(19) United States
(12) Patent Application Publication
(10) Pub. No.: US 2026/0107293 A1
(43) Pub. Date: Apr. 16, 2026

(54) METHOD FOR USER EQUIPMENT, METHOD FOR ACCESS NETWORK NODE, USER EQUIPMENT, AND ACCESS NETWORK NODE

(71) Applicant: NEC Corporation, Minato-ku, Tokyo (JP)

(72) Inventor: Zhe CHEN, Guildford (GB)

(73) Assignee: NEC Corporation, Minato-ku, Tokyo (JP)

(21) Appl. No.: 19/113,999

(22) PCT Filed: Sep. 26, 2023
(86) PCT No.: PCT/JP2023/034989

§ 371 Date: Mar. 21, 2025

(30) Foreign Application Priority Data
Oct. 12, 2022 (GB) 2215057.7

(51) Int. Cl. H04W 72/30; H04W 76/27

(52) U.S. Cl. CPC H04W 72/30; H04W 76/27

(57) ABSTRACT

A method for a user equipment, UE, (3) is disclosed. The method includes: receiving, from an access network node (5), a message for causing the UE (3) to move to a radio resource control, RRC, inactive state, the message including information indicating that the UE (3) can keep configuration for a point-to-multipoint, PTM, transmission of a multicast while the UE (3) is in the RRC inactive state; and keeping the configuration for the PTM transmission while the UE (3) is in the RRC inactive state, based on the information.

### TECHNICAL FIELD

The present disclosure relates to a wireless communication system and devices thereof operating according to the 3rd Generation Partnership Project (3GPP) standards or equivalents or derivatives thereof. The disclosure has particular, but not exclusive, relevance to improvements related to multicast and broadcast (MBS) services.

### BACKGROUND ART

Under the 3GPP standards, a NodeB (or an ‘eNB’ in LTE, ‘gNB’ in 5G) is a base station via which communication devices (user equipment or ‘UE’) connect to a core network and communicate to other communication devices or remote servers. End-user communication devices are commonly referred to as User Equipment (UE) which may be operated by a human or comprise automated devices. Such communication devices might be, for example, mobile communication devices such as mobile telephones, smartphones, smart watches, personal digital assistants, laptop/tablet computers, web browsers, e-book readers, connected vehicles, and/or the like. Such mobile (or even generally stationary) devices are typically operated by a user (and hence they are often collectively referred to as user equipment, ‘UE’) although it is also possible to connect Internet of Things (IoT) devices and similar Machine Type Communications (MTC) devices to the network. For simplicity, the present application will use the term base station to refer to any such base stations and use the term mobile device or UE to refer to any such communication device.

The latest developments of the 3GPP standards are the so-called ‘5G’ or ‘New Radio’ (NR) standards which refer to an evolving communication technology that is expected to support a variety of applications and services such as MTC, IoT/Industrial IoT (IIoT) communications, vehicular communications and autonomous cars, high resolution video streaming, smart city services, and/or the like. 3GPP intends to support 5G by way of the so-called 3GPP Next Generation (NextGen) radio access network (RAN)/radio access technology (RAT) and the 3GPP NextGen core (NGC) network. Various details of 5G networks are described in, for example, the ‘NGMN 5G White Paper’ V1.0 by the Next Generation Mobile Networks (NGMN) Alliance, which document is available from https://www.ngmn.org/5g-white-paper.html.

Multicast and broadcast services (MBS) enable resource-efficient delivery of transmissions for groups of user equipment (UEs). For example, multicast communication to a group of UEs typically requires less overall bandwidth than a corresponding set of separate unicast (one to one) communications. Multicast transmissions to UEs that are in a radio resource control (RRC) connected state are able to provide higher quality of service (QOS) levels, improved reliability and better continuity than can be provided using broadcast. MBS may be used, for example, for public safety and mission critical applications, vehicle-to-everything (V2X) applications, or video delivery to a group of UEs. However, there is a need for improved MBS methods and procedures for providing improved resource efficiency, improved capacity, and reduced network congestion. Some multicast services may require the UE to be in the RRC connected state. However, maintaining the UE in the RRC connected state is not power efficient, for example due to uplink transmissions for Hybrid Automatic Repeat Request (HARQ) and reporting that is performed in the RRC connected state, and may also result in increased congestion in the cell. There is a need, therefore, for improved MBS services (e.g. multicast, including point to multipoint (PTM) and point to point (PTP) transmissions) that can be supported even when the UE is in an RRC inactive state.

More generally, there is a need for improved mechanisms and procedures for MBS. These mechanisms and procedures include, but are not limited to, procedures for configuring and/or maintaining a PTM leg for MBS when a UE is in an RRC inactive state.

### CITATION LIST

### Non Patent Literature

NPL 1: ‘NGMN 5G White Paper’ V1.0

### SUMMARY OF INVENTION

### Technical Problem

The present disclosure seeks to provide methods and associated apparatus that address or at least ameliorate (at least some of) the above-described issues.

### Solution to Problem

In a first aspect the present disclosure provides a method for a user equipment, UE, the method comprising: receiving, from an access network node, a message for causing the UE to move to a radio resource control, RRC, inactive state, the message including information indicating that the UE can keep configuration for a point-to-multipoint, PTM, transmission of a multicast while the UE is in the RRC inactive state; and keeping the configuration for the PTM transmission while the UE is in the RRC inactive state, based on the information.

The information may include an identity of a bearer for the PTM transmission, and the keeping may be performed by keeping the configuration for the PTM transmission corresponding to the bearer for the PTM transmission.

The configuration for the PTM transmission may include radio link control, RLC, configuration that includes an indication indicating that an RLC bearer for the PTM transmission can be used in a case where the UE is in the RRC inactive state.

The method may further comprise determining, based on the information, to maintain a PTM radio link control, RLC, entity of a radio bearer of one or more radio bearers for the PTM transmission.

The message may include an RRC release message.

The method may further comprise receiving, from the access network node, in a case where the UE is in an RRC connected state, the PTM transmission: entering the RRC inactive state in response to the receiving the message; and receiving, in the RRC inactive state, from the access network node, the PTM transmission using the configuration.

The method may further comprise joining a multicast session for receiving the PTM transmission: entering the RRC inactive state: receiving, from the access network node, in a case where the multicast session is inactive, a further message indicating that the UE is to enter an RRC connected state, wherein the further message includes an indication of at least one service of the PTM transmission supported by the access network node: transmitting, to the access network node, in response to receiving the further message, an indication of a PTM transmission of the multicast to be received: entering the RRC connected state: receiving, from the access network node, a bearer configuration for the PTM transmission; entering the RRC inactive state in response to the receiving the message; and receiving, while the UE is in the RRC inactive state, the PTM transmission.

The further message may be a paging message.

The transmitting the indication of the PTM transmission of the multicast to be received may be via an RRC resume message, and the receiving the bearer configuration for the PTM transmission may be via an RRC reconfiguration message.

In a second aspect the present disclosure provides a method for a user equipment, UE, the method comprising: receiving, from an access network node, in a case where the UE is in a radio resource control, RRC, inactive state, a message for causing the UE to enter an RRC connected state; and determining, based on whether the UE stores multicast configuration information for receiving a multicast transmission from the access network node, to not to enter an RRC connected state.

The message may include a paging message including a temporary mobile group identity, TMGI, and the determining may be performed based on whether the UE stores the multicast configuration information corresponding to the TMGI.

The multicast configuration information may include an indication of a configuration of at least one radio bearer for receiving the multicast transmission from the access network node.

In a third aspect the present disclosure provides a method for an access network node the method comprising: transmitting, to a user equipment, UE, a message for causing the UE to move to a radio resource control, RRC, inactive state, the message including information indicating that the UE can keep configuration for a point-to-multipoint, PTM, transmission of a multicast while the UE is in the RRC inactive state, wherein the configuration for the PTM transmission may be kept by the UE while the UE is in the RRC inactive state, based on the information.

In a fourth aspect the present disclosure provides a method for an access network node, the method comprising: transmitting, to a user equipment, UE, in a case where the UE is in a radio resource control, RRC, inactive state, a message for causing the UE to enter an RRC connected state, wherein based on whether the UE stores multicast configuration information for receiving a multicast transmission from the access network node, not to enter an RRC connected state is determined.

In a fifth aspect the present disclosure provides a user equipment, UE, comprising: means for receiving, from an access network node, a message for causing the UE to move to a radio resource control, RRC, inactive state, the message including information indicating that the UE can keep configuration for a point-to-multipoint, PTM, transmission of a multicast while the UE is in the RRC inactive state; and means for keeping the configuration for the PTM transmission while the UE is in the RRC inactive state, based on the information.

In a sixth aspect the present disclosure provides a user equipment, UE, comprising: means for receiving, from an access network node, in a case where the UE is in a radio resource control, RRC, inactive state, a message for causing the UE to enter an RRC connected state; and means for determining, based on whether the UE stores multicast configuration information for receiving a multicast transmission from the access network node, to not to enter an RRC connected state.

In a seventh aspect the present disclosure provides an access network node comprising: means for transmitting, to a user equipment, UE, a message for causing the UE to move to a radio resource control, RRC, inactive state, the message including information indicating that the UE can keep configuration for a point-to-multipoint, PTM, transmission of a multicast while the UE is in the RRC inactive state, wherein the configuration for the PTM transmission may be kept by the UE while the UE is in the RRC inactive state, based on the information.

In an eighth aspect the present disclosure provides an access network node comprising: means for transmitting, to a user equipment, UE, in a case where the UE is in a radio resource control, RRC, inactive state, a message for causing the UE to enter an RRC connected state, wherein based on whether the UE stores multicast configuration information for receiving a multicast transmission from the access network node, not to enter an RRC connected state may be determined.

### BRIEF DESCRIPTION OF DRAWINGS

Example embodiments of the present disclosure will now be described, by way of example, with reference to the accompanying drawings.

FIG. 1 illustrates schematically a mobile (cellular or wireless) telecommunication system to which example embodiments of the present disclosure may be applied.

FIG. 2 is a schematic block diagram of a mobile device.

FIG. 3 is a schematic block diagram of an access network node (e.g. base station).

FIG. 4 shows a schematic block diagram of a distributed unit of RAN equipment for the telecommunication system shown in FIG. 1.

FIG. 5 shows is a schematic block diagram of a central unit of RAN equipment for the telecommunication system shown in FIG. 1.

FIG. 6 shows an illustration of point-to-point (PTM) and point-to-multipoint (PTM) communications.

FIG. 7 shows a flow diagram illustrating a method in which a UE continues to receive a multicast transmission in an RRC inactive state.

FIG. 8 shows an example of information for maintain a PTM leg at a UE.

FIG. 9 illustrates a method in which an MBS radio bearer (MRB) list is transmitted to the UE.

FIG. 10 shows a first example of an RLC configuration.

FIG. 11 shows a second example of an RLC configuration.

FIG. 12 illustrates a method in which a UE enters an RRC connected state and receives an MRB configuration.

FIG. 13 illustrates a further method in which the UE enters the RRC connected state.

FIG. 14 illustrates a first part of a method of establishing and joining a multicast session.

FIG. 15 illustrates a second part of the method of establishing and joining the multicast session.

FIG. 16 illustrates a third part of the method of establishing and joining the multicast session.

FIG. 17 illustrates a first part of a method of MBS session activation and deactivation.

FIG. 18 illustrates a second part of the method of MBS session activation and deactivation.

FIG. 19 illustrates a method in which a UE does not enter the RRC connected state if a PTM configuration is available at the UE 3.

### DESCRIPTION OF EXAMPLE EMBODIMENTS

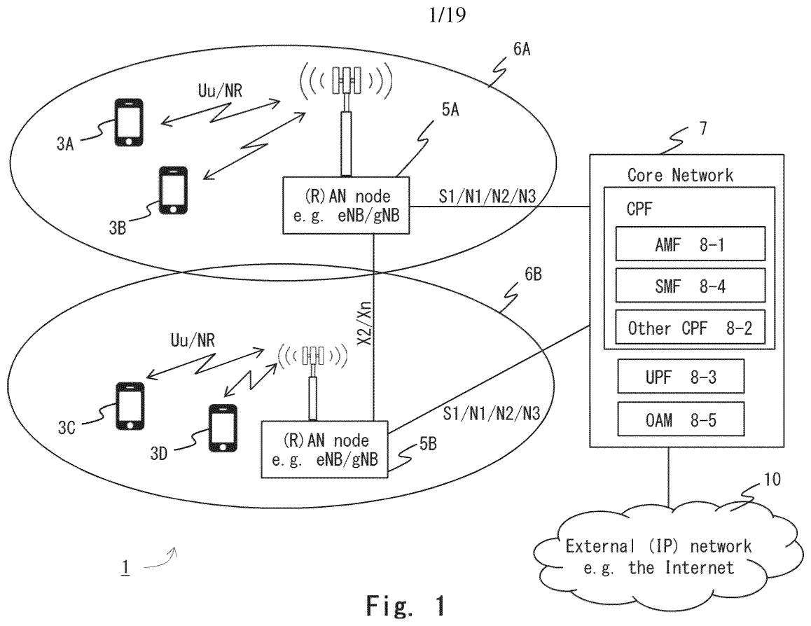

FIG. 1 illustrates schematically a mobile (cellular or wireless) telecommunication system 1 to which example embodiments of the present disclosure may be applied.

In this system 1, users of mobile devices 3 (UEs) can communicate with each other and other users via base stations 5 (and other access network nodes) and a core network 7 using an appropriate 3GPP radio access technology (RAT), for example, an Evolved Universal Terrestrial Radio Access (E-UTRA), a 5G RAT, and/or later generation Radio Access Technologies. It will be appreciated that a number of base stations 5 form a (radio) access network or (R)AN. As those skilled in the art will appreciate, whilst four mobile devices 3A, 3B, 3C and 3D and two base stations 5A and 5B are shown in FIG. 1 for illustration purposes, the system, when implemented, will typically include other base stations/(R)AN nodes 5 and mobile devices (UEs) 3.

Each base station 5 controls one or more associated cells 6 (either directly or via other nodes such as home base stations, relays, remote radio heads, distributed units, and/or the like). A base station 5 that supports Next Generation/5G protocols may be referred to as a ‘gNB’. It will be appreciated that some base stations 5 may be configured to support both 4G and 5G, and/or any other 3GPP or non-3GPP communication protocols. It will be appreciated that a number of base stations 5 form a (radio) access network or (R)AN.

### User Equipment (UE)

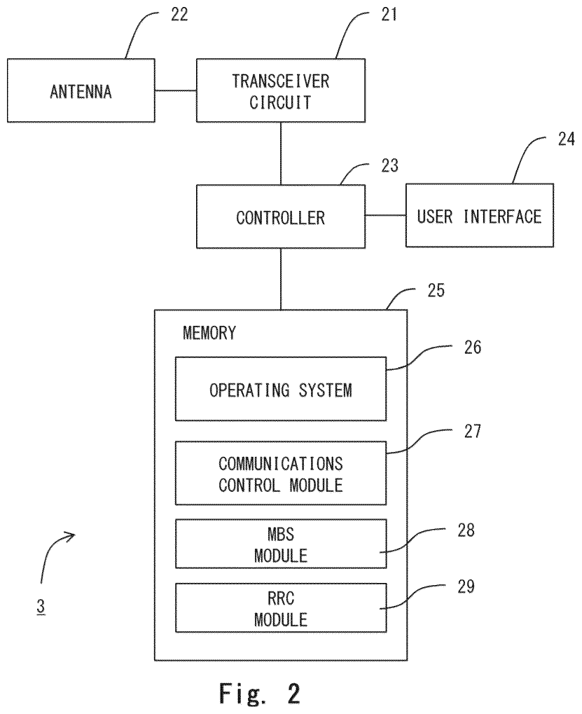

FIG. 2 is a block diagram illustrating the main components of the mobile device (UE) 3 shown in FIG. 1. As shown, the UE 3 includes a transceiver circuit 21 which is operable to transmit signals to and to receive signals from one or more connected nodes via one or more antennas 22. Although not necessarily shown in FIG. 2, the UE 3 will of course have all the usual functionality of a conventional mobile device (such as a user interface 24) and this may be provided by any one or any combination of hardware, software and firmware, as appropriate. A controller 23 controls the operation of the UE 3 in accordance with software stored in a memory 25. The software may be pre-installed in the memory 25 and/or may be downloaded via the telecommunication network 1 or from a removable data storage device (RMD), for example. The software includes, among other things, an operating system 26, a communications control module 27, an MBS module 28 and an RRC module 29.

The communications control module 27 is responsible for handling (generating/sending/receiving) signalling messages and uplink/downlink data packets between the UE 3 and other nodes, including (R)AN nodes 5, and core network nodes. The signalling may comprise control signalling (such as RRC signalling) related to configuring and assisting cell reselection by the UE 3.

The MBS module 28 is responsible for controlling MBS communications (generating, sending, and receiving transmissions). For example, the MBS module 28 may be configured to perform control for receiving a multicast communication. It will be appreciated that the MBS module 28 may be configured to perform control for MBS communications in any of the methods described below. The RRC module 29 is responsible for controlling the RRC state of the UE 3. For example, the RRC module 29 may control the UE to enter into an RRC connected state, or an RRC inactive state, in response to receiving a corresponding indication from a base station 5. It will be appreciated that the RRC module 29 may be configured to perform control of the RRC state of the UE 3 in any of the methods described below.

### Base Station/Gateway (Access Network Node)

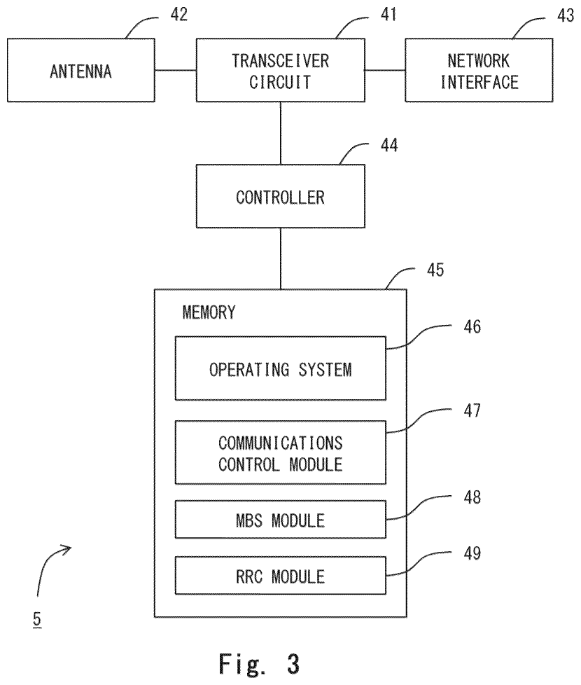

FIG. 3 is a block diagram illustrating the main components of the gateway/base station 5 shown in FIG. 1 (a base station (gNB) or a similar access network node, the base station need not necessarily be a gNB 6). As shown, the gateway/base station 5 includes a transceiver circuit 41 which is operable to transmit signals to and to receive signals from one or more connected UEs 3 via one or more antennas 42 and to transmit signals to and to receive signals from other network nodes (either directly or indirectly) via a network interface 43. The network interface 43 typically includes an appropriate base station-base station interface (such as X2/Xn) and an appropriate base station-core network interface (such as S1/NG-C/NG-U). A controller 44 controls the operation of the base station 5 in accordance with software stored in a memory 45. The software may be pre-installed in the memory 45 and/or may be downloaded via the telecommunication network 1 or from a removable data storage device (RMD), for example. The software includes, among other things, an operating system 46, a communications control module 47, and an MBS module 48 and an RRC module.

The communications control module 47 is responsible for handling (generating/sending/receiving) signalling between the base station 5 and other nodes, such as the UE 3 and core network nodes. The signalling may comprise control signalling (such as RRC signalling) related to configuring and assisting cell reselection by the UE 3.

The MBS module 48 is responsible for controlling MBS procedures and methods, including MBS transmissions (generating, sending, and receiving transmissions). For example, the MBS module 48 may control the transmission of a multicast, including a PTM transmission, to a set of UEs 3. It will be appreciated that the MBS module 48 may be configured to perform control in any of the methods for MBS described below.

The RRC module is responsible for controlling RRC communications. For example, the RRC module 29 may control communications to cause a UE 3 to enter into an RRC connected state, or an RRC inactive state, by transmitting a corresponding indication to the UE 3. It will be appreciated that the RRC module 29 may be configured to control communications for RRC in any of the methods described below.

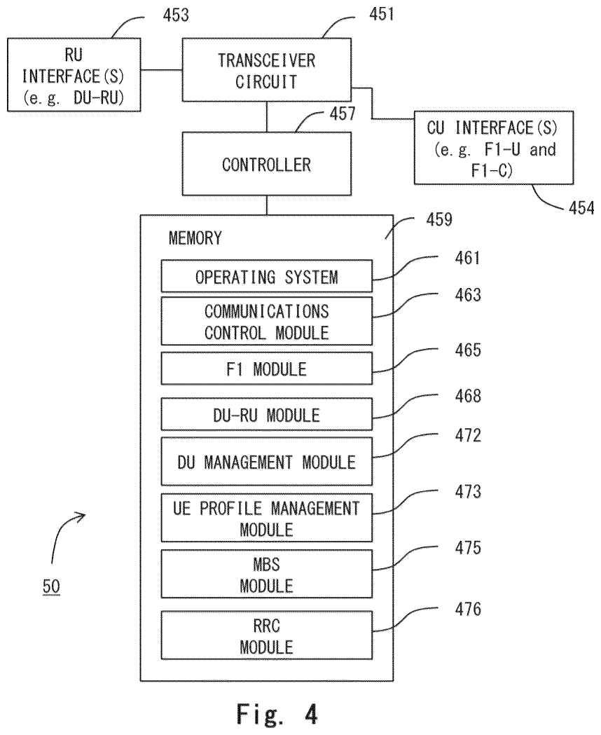

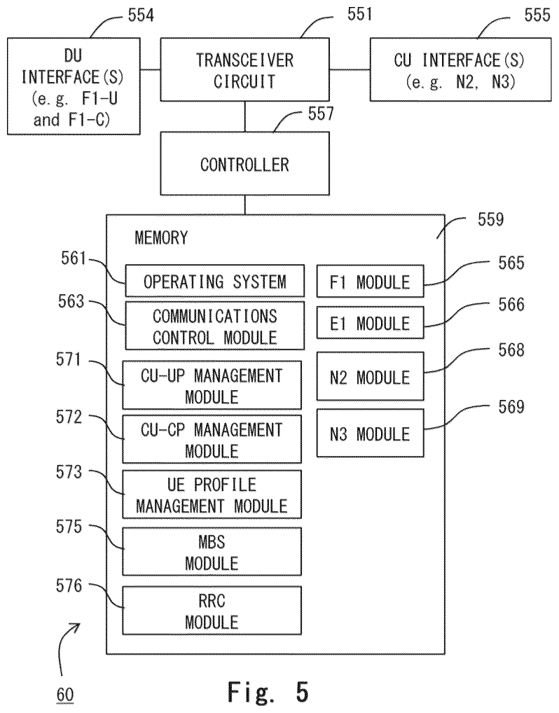

The present disclosure also relates to a base station (referred to as a ‘distributed’ base station or gNB) that is split between one or more distributed units (DUs) 50 and a central unit (CU) 60, with a CU 60 typically performing higher level functions and communication with the next generation core and with the DU 50 performing lower level functions and communication over an air interface with UEs 3 in the vicinity (i.e. in a cell operated by the gNB 5). In the present disclosure, the DU 50 may also be referred to as ‘a first unit’ of an access network node 5 for radio communication with a UE 3, and the CU 60 may be referred to as a ‘second unit’ of the access network node 5. An example of a distributed base station 5 will now be described in more detail, with reference to FIGS. 4 and 5. However, it will be appreciated that the (R)AN node 5 need not necessarily be a gNB.

A distributed gNB 5 includes the following functional units:
gNB Central Unit (gNB-CU): a logical node hosting Radio Resource Control (RRC), Service Data Adaptation Protocol (SDAP) and Packet Data Convergence Protocol (PDCP) layers of the gNB (or RRC and PDCP layers of an en-gNB) that controls the operation of one or more gNB-DUs. The gNB-CU terminates the so-called F1 interface connected with the gNB-DU.
gNB Distributed Unit (gNB-DU): a logical node hosting Radio Link Control (RLC), Medium Access Control (MAC) and Physical (PHY) layers of the gNB or en-gNB, and its operation is partly controlled by gNB-CU. One gNB-DU supports one or multiple cells. One cell is supported by only one gNB-DU. The gNB-DU terminates the F1 interface connected with the gNB-CU.
gNB-CU-Control Plane (gNB-CU-CP): a logical node hosting the RRC and the control plane part of the PDCP protocol of the gNB-CU for an en-gNB or a gNB. The gNB-CU-CP terminates the so-called E1 interface connected with the gNB-CU-UP and the F1-C(F1 control plane) interface connected with the gNB-DU.
gNB-CU-User Plane (gNB-CU-UP): a logical node hosting the user plane part of the PDCP protocol of the gNB-CU for an en-gNB, and the user plane part of the PDCP protocol and the SDAP protocol of the gNB-CU for a gNB. The gNB-CU-UP terminates the E1 interface connected with the gNB-CU-CP and the F1-U (F1 user plane) interface connected with the gNB-DU.

It will be appreciated that when a distributed base station or a similar control plane-user plane (CP-UP) split is employed, the base station 5 may be split into separate control-plane and user-plane entities, each of which may include an associated transceiver circuit, antenna, network interface, controller, memory, operating system, and communications control module. When the base station 5 comprises a distributed base station, the network interface also includes an E1 interface and an F1 interface (F1-C for the control plane and F1-U for the user plane) to communicate signals between respective functions of the distributed base station 5. In this case, the communications control module is also responsible for communications (generating, sending, and receiving signalling messages) between the control-plane and user-plane parts of the base station 5.

### RAN Equipment (DU)

FIG. 4 is a schematic block diagram illustrating the main components of a DU 50 that may be used as part of the RAN equipment 5 for the communication system 1 shown in FIG. 1. As shown, the DU 50 has a transceiver circuit 451 for: transmitting signals to, and for receiving signals from, the communication devices (such as UEs 3) via the radio unit (RU) and the associated DU-RU interface 453; and for transmitting signals to, and for receiving signals from, the CU 60 of the RAN equipment 5 via a CU interface 454 (e.g. comprising an F1 interface which may be split into an F1-U and an F1-C interface for user plane and control plane signalling respectively).

The DU 50 has a controller 457 to control the operation of the DU 50. The controller 457 is associated with a memory 459. Software may be pre-installed in the memory 459 and/or may be downloaded via the communications network 1 or from a removable data storage device (RMD) for example. The controller 457 is configured to control the overall operation of the DU 50 by, in this example, program instructions or software instructions stored within the memory 459.

As shown, these software instructions include, among other things, an operating system 461, a communications control module 463, an F1 module 465, a DU-RU module 468, a DU management module 472, a UE profile management module 473 an MBS module 475, and an RRC module 476. The functions of the MBS module 475 and the RRC module 476 are the same as described above with reference to FIG. 3, depending on the functional split between the RU, DU 50 and the CU 60.

The communications control module 463 is operable to control the communication between the DU 50 and one or more RUs (and hence between the DU 50 and the UE 3), and between the DU 50 and the CU 60. The communications control module 463 is configured for the overall control of the reception of signals corresponding to uplink communications from the UE 3 and for handling the transmission of downlink communications destined for the UE 3.

The F1 module 465 is responsible for the appropriate processing of signals received from, or transmitted to, the CU 60 via one or more CU (e.g. F1) interfaces 454. These signals may be separated into: user plane signals received from, or transmitted to, the CU-UP part of the CU 60 via the F1-U interface; and control plane signals received from, or transmitted to, the CU-CP part of the CU 60 via the F1-C interface.

The DU-RU module 468 is responsible for the appropriate processing of signals received from, or transmitted to, the RU via one or more RU (e.g. DU-RU) interfaces 453.

The DU management module 472 is responsible for managing the overall operation of the DU 50 and the overall performance of the tasks required of the DU 50. These tasks include, among other things, the generation and transmission of appropriate messages using appropriate signalling application protocols, depending on the functional split between the RU, DU 50 and CU 60, such as interpretation of received MAC signalling and the generation of MAC signalling for transmission.

The UE profile management module 473 is responsible for carrying out functions related to the UE profile including (where applicable): the reception and storage of the UE profile or related assistance/preference information from the UE 3 or from elsewhere in the network: the determination (where applicable) of appropriate mobility specific configurations, based on the UE profile/assistance information/preference information, for implementation at the UE 3 and/or RAN equipment; and/or the provision of configuration information (where applicable) for configuring the UE appropriately with mobility based configurations. It will be appreciated that, depending on implementation, the gNB-DU may not implement at least some of these features.

### RAN Equipment (CU)

FIG. 5 is a schematic block diagram illustrating the main components of a CU 60 of the RAN equipment for the communication system 1 shown in FIG. 1. As shown, the CU 60 has a transceiver circuit 551 for: transmitting signals to, and for receiving signals from, the DU 50 via one or more DU interfaces 554 (e.g. comprising an F1 interface which may be split into an F1-U and an F1-C interface for user plane and control plane signalling respectively); and for transmitting signals to, and for receiving signals from, the functions of the core network 7 via one or more core network interfaces 555 (e.g. comprising the N2 and N3 interfaces or the like).

The CU 60 has a controller 557 to control the operation of the CU 60. The controller 557 is associated with a memory 559. Software may be pre-installed in the memory 559 and/or may be downloaded via the communications network 1 or from a removable data storage device (RMD) for example. The controller 557 is configured to control the overall operation of the CU 60 by, in this example, program instructions or software instructions stored within the memory 559.

As shown, these software instructions include, among other things, an operating system 561, a communications control module 563, an F1 module 565, an E1 module 566, an N2 module 568, an N3 module 569, a CU-UP management module 571, a CU-CP management module 572, a UE profile management module 573, an MBS module 575 and an RRC module 576. The functions of the MBS module 575 and the RRC module 576 are the same as described above with reference to FIG. 3, depending on the functional split between the RU, DU 50 and the CU 60.

The communications control module 563 is operable to control the communication between the CU 60 and one or more DUs 50 (and hence between the CU 60 and the UE 3), and between the CU 60 and the core network 7. The communications control module 563 is configured for the overall control of the reception of signals corresponding to uplink communications from the UE 3 and for handling the transmission of downlink communications destined for the UE 3.

The F1 module 565 is responsible for the appropriate processing of signals received from, or transmitted to, the DU 50 via one or more DU (e.g. F1) interfaces 554. These signals may be separated into: user plane signals received at, or transmitted by, the CU-UP part of the CU 60 via the F1-U interface; and control plane signals received at, or transmitted by, the CU-CP part of the CU 60 via the F1-C interface.

The E1 module 566 is responsible for the appropriate processing of signals transmitted between the CU-UP part of the CU 60 and the CU-CP part of the CU 60 via the corresponding internal CU interface (e.g. E1).

The N2 module 568 is responsible for the appropriate processing of signals received from, or transmitted to, the AMF 8-1 via one or more corresponding core network interfaces (e.g. N2) 555.

The N3 module 569 is responsible for the appropriate processing of signals received from, or transmitted to, one or more core network user plane functions 8-3 via one or more corresponding core network interfaces (e.g. N3) 555.

The CU-UP management module 571 is responsible for managing the overall operation of the CU-UP part of the CU 60 and the overall performance of the tasks required of the CU-UP.

The CU-CP management module 572 is responsible for managing the overall operation of the CU-CP part of the CU 60 and the overall performance of the tasks required of the CU-CP. These tasks include, among other things, the generation and transmission of appropriate messages using appropriate signalling application protocols, depending on the functional split between the RU, DU 50 and CU 60, such as interpretation of received RRC signalling and the generation of RRC signalling for transmission.

The UE profile management module 573 is responsible for carrying out functions related to the UE (mobility) profile including (where applicable): the reception and storage of the UE profile or related assistance/preference information from the UE 3 or from elsewhere in the network: the determination of appropriate mobility specific configurations, based on the UE profile/assistance information/preference information, for implementation at the UE 3 and/or RAN equipment 5; and/or the provision of configuration information for configuring the UE appropriately with mobility based configurations. It will be appreciated that, depending on implementation, the gNB-CU 60 may not implement at least some of these features.

The mobile device 3 and its serving base station 5 are connected via an appropriate air interface (for example the so-called ‘NR’ air interface, the ‘Uu’ interface, and/or the like).

The core network 7 (e.g. the EPC in case of LTE or the NGC in case of NR/5G) typically includes logical nodes (or ‘functions’) for supporting communication in the telecommunication system 1, and for subscriber management, mobility management, charging, security, call/session management (amongst others). For example, the core network 7 of a ‘Next Generation’/5G system will include user plane entities and control plane entities, such as one or more control plane functions (CPFs) and one or more user plane functions (UPFs) 8-3. The one or more control plane functions (CPFs) include a control plane function 8-1 that is responsible for handling connection and mobility tasks for the mobile devices 3, such as the so-called Access and Mobility Management Function (AMF) in 5G, or the Mobility Management Entity (MME) in 4G. The one or more control plane functions (CPFs) also include a control plane function that is 8-4 that is responsible for handling communication sessions for the mobile devices 3 such as session establishment, modification and release (such as the Session Management Function (SMF)), and may also include one or more additional control plane functions 8-2. The Operations, Administration and Maintenance (OAM) function 8-5 may be implemented in software in one or more 5G CN nodes. As shown in FIG. 1, the core network 7 is coupled to a data network 10, such as the Internet or a similar Internet Protocol (IP) based network.

When the UE 3 initially establishes a radio resource control (RRC) connection with a base station 5 via a cell it registers with an appropriate core network node 8-1 (e.g, AMF, MME). The UE 3 is in the so-called RRC connected state and an associated UE context is maintained by the network. When the UE 3 is in the so-called RRC inactive or in the RRC inactive state, it may select an appropriate cell for camping so that the network is aware of the approximate location of the UE 3 (although not necessarily on a cell level).

### Multicast and Broadcast Services (MBS)

Methods for MBS will now be described. The present examples relate to multicast transmissions. In particular, methods for maintaining multicast transmissions between a base station 5 and a UE 3, including point-to-multipoint (PTM) transmissions, will be described.

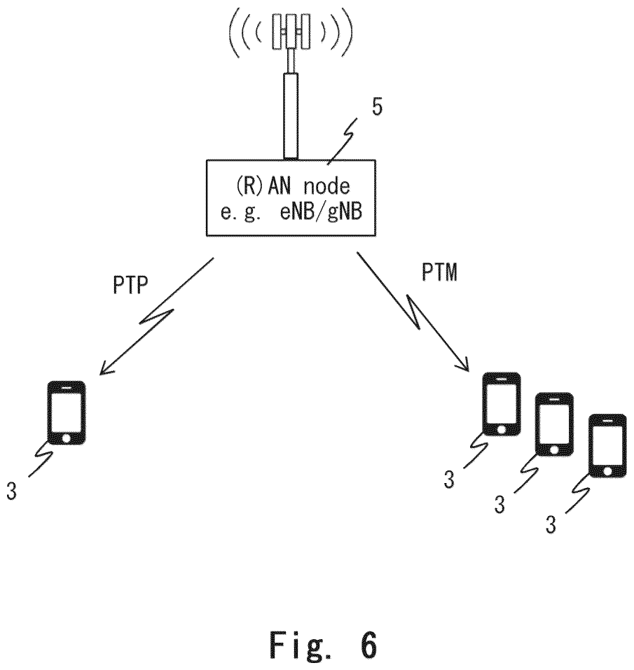

A multicast service may include a PTP leg between a base station 5 and a single UE 3, and a PTM leg between the base station 5 and a plurality of UEs 3. PTP and PTM transmissions are illustrated schematically in FIG. 6. It will be appreciated that whilst the UEs 3 are shown separately in FIG. 6, a UE 3 may receive both the PTP and PTM parts of the multicast. PTP may be described as a PTP ‘leg’ or ‘part’ of a multicast transmission. Similarly, PTM may be described as a PTM ‘leg’ or ‘part’ of a multicast transmission.

The PTM leg has an MBS radio bearer (MRB) in the MBS session, that has a corresponding MRB configuration. Each MRB may have an associated identifier (e.g. MRB-Identity) that can be used to identify the MRB. The MRB identity may be included in any suitable transmission for MRB configuration. A multicast service may be suspended (a process in which MRBs are released) or re-activated based on multicast data activity (or inactivity). The configuration of one or more MRBs may be provided to the UE 3 and/or the base station 5, for example, in any suitable radio link control (RLC) configuration signalling (e.g. in an RLC Bearer Configuration message).

Multicast MRBs may be suspended when the UE 3 transitions from an RRC connected state to the RRC inactive state. A PTP leg of the multicast may be unsuitable for use when UE is in RRC inactive state because the PTP leg is UE specific, and the resources required to provide the PTP leg may increase linearly with the number of UEs. However, in the present examples, advantageously the PTM part of the multicast can be maintained (or configured) even when the UE 3 is in the RRC inactive state.

When a UE 3 performs cell reselection to a neighbouring cell in the RRC inactive state (without resuming the RRC connection), it is advantageous to be able maintain reception of multicast transmissions. Methods of configuring, resuming and maintaining a multicast when a UE is in the RRC inactive state will be described later.

Improved procedures for maintaining a PTM leg of a multicast when a UE 3 transitions from an RRC connected state to an RRC inactive state will now be described. It will be appreciated that the in the methods described below the PTM transmissions from the base station may be received by received by UEs that are in the RRC inactive state as well as UEs that are in the RRC connected state.

### Maintaining PTM for a Multicast

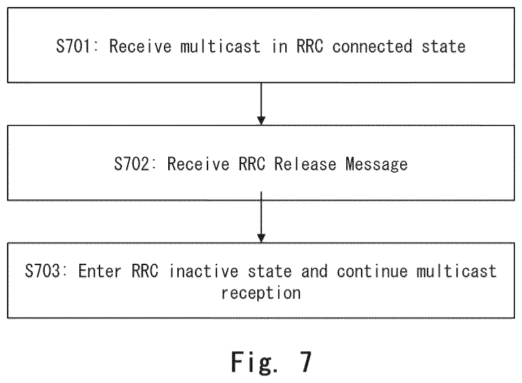

FIG. 7 shows an example in which a UE 3 transitions from an RRC connected state to an RRC inactive state, but advantageously maintains a PTM leg of a multicast transmission.

In step S701 the UE 3 is in the RRC connected state and receives a multicast transmission from a base station (an access network node) 5. An MRB including a PTM leg has been configured for the UE 3, and a PTM leg may also have been configured for the UE 3.

In step S702, the UE 3 receives an RRC Release message from the base station 5. The base station 5 may determine to transmit the RRC Release message to the UE 3, for example, in order to reduce congestion in a cell of the base station 5, or due to a period of data inactivity for the multicast. The RRC Release message may include an indication that a corresponding configuration is to be suspended (e.g. an information element such as suspendConfig). Advantageously, in the present example, the RRC Release message includes (e.g. in SuspendConfig) information for maintaining at least one PTM leg at the UE 3 (e.g. information indicating that the UE 3 is to store information corresponding to the PTM leg). The information for maintaining at least one PTM leg may also be referred to as a ‘multicast indication’.

In step S703, the UE 3 enters an RRC inactive state in response to receiving the RRC Release message. However, since the UE 3 received, in the RRC release message of step S702, the information for maintaining the PTM leg, the UE 3 is advantageously able to continue to receive the PTM leg of the multicast transmission.

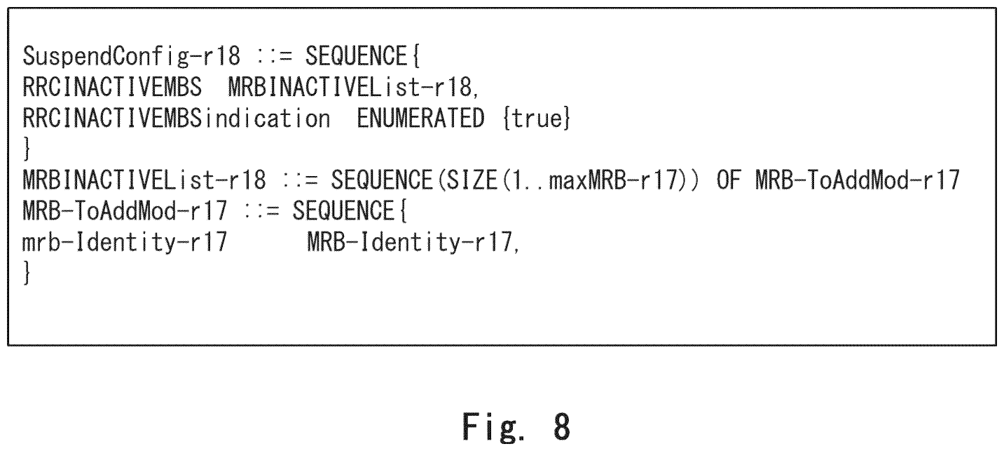

An example of information for maintaining at least one PTM leg at the UE 3 that may be included in the RRC Release message is shown in FIG. 8. However, it will be appreciated that the information for maintaining the at least one PTM leg at the UE 3 may have any other suitable format. In this example, the information includes an indication ‘RRCINACTIVEMBS’, that is an indication of whether the UE 3 should keep (maintain) the PTM RLC entity of the MRB of the multicast when the UE 3 is in the RRC inactive state. In other words, upon reception of the indication, the UE 3 determines whether to maintain the PTM RLC entity of the MRB. The indication may be, for example, ‘TRUE’ indicating that the UE 3 is to maintain the PTM RLC entity of the MRB, or ‘FALSE’ indicating that the UE 3 is not to maintain the PTM RLC entity of the MRB (although it will be appreciated that the indication need not necessarily be ‘TRUE’ or ‘FALSE’, and that any other suitable indication such as ‘0’ or ‘1’ could alternatively be used). As shown in FIG. 8, in this example the information included in the RRC release message includes a list of MRB, and the UE 3 may determine to maintain the PTM RLC entity for the MRB indicated in the list.

In a case where the MBS session has finished or deactivated, the indication of whether the UE 3 should maintain at least one PTM leg can be used to indicate that the PTM leg is not to be maintained at the UE 3.

The RRC release message received at the UE 3 from the network (e.g. from the base station 5) may include an indication of a configuration for MBS for a neighbouring cell. The information may include a neighbour cell configuration that is associated with an MBS session list. The neighbour cell MBS session configuration can be used to implicitly indicate which MBS session (MRB) is to be maintained when the UE 3 enters the RRC inactive state. However, an explicit indication such as that illustrated in FIG. 8 may be preferable, in order to avoid any ambiguity for the indication.

### DU and CU

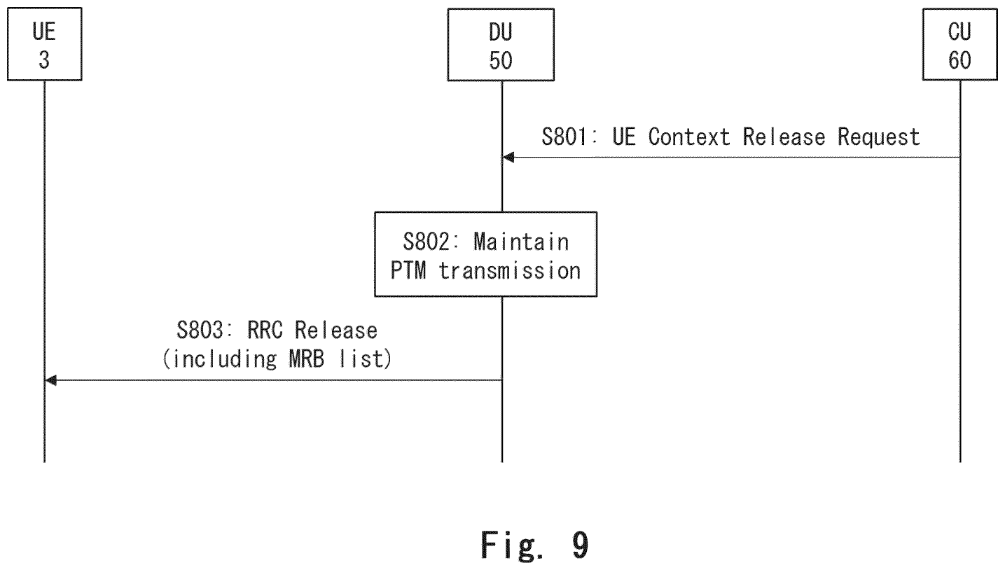

FIG. 9 shows an example in which an MRB list is transmitted to the UE 3 as part of an RRC release procedure involving a DU 50 and a CU 60. The DU 50 may also be referred to as ‘a first unit’ of an access network node 5 for radio communication with a UE 3, and the CU 60 may be referred to as a ‘second unit’ of the access network node 5. At the beginning of the method shown in FIG. 9 the UE 3 is in the RRC connected state and is receiving a multicast transmission from the DU 50, including a PTM transmission.

In step S801, the CU 60 transmits a UE Context Release Request message to the DU 50. The UE Context Release Request includes an identifier of the UE (e.g. ‘UE ID’). In this example, the UE Context Release Request also includes a list of MRB to be maintained for the UE 3 when the UE 3 enter an RRC inactive state. Alternatively, or the UE Context Release Request may include an indication that all of the MRB for PTM transmission for the UE 3 are to be maintained (e.g. using an indication such as ‘KeepPTMindication’ which may be, for example: ‘TRUE’ or ‘FALSE’: or similarly, ‘1’ or ‘0’). The indication of which MRB that the DU 50 should keep (e.g. continue store a configuration for, or transmit) may be in the form of any suitable information element or list, such as ‘MRB_ID list of INACTIVE’. Upon reception of the indication included in the UE Context Release Request, the DU 50 may determine to keep the UE 3 context, and keep one or more multicast F-U tunnels which is (are) associated with the list of bearers (e.g. ‘MRB_ID list of INACTIVE’) with the CU-UP. Since the indication included in the UE Context Release Request corresponds to a particular UE 3, the indication may be referred to as a ‘UE specific’ indication. Based on the indication, the DU 50 is able to determine which MBS service the UE 3 is to receive when the UE 3 is in the RRC inactive state.

In step S802, the DU 50 determines to maintain the MRB for PTM transmission based on the information included in the UE Context Release Request. The DU 50 may determine, based on an indication in the UE Context Release Request, that the DU 50 is to continue PTM transmissions for the UE 3 (e.g. all of the PTM transmissions from the DU 50, or a set of PTM transmissions indicated in the UE Context Release Request).

In step S803, the DU 50 transmits an RRC release message to the UE 3. The RRC release message includes a set (e.g. a list) of the MRB for the PTM transmissions that are to be maintained at the UE 3. The UE 3 receives the MRB list and determines to maintain (e.g. continue to store a configuration for) the MRB indicated in the list. The set of the MRB may also be referred to as a ‘multicast indication’. The UE 3 may maintain a PTM leg corresponding to the MRB indicated in the MRB list. Advantageously, therefore, the UE 3 is able to continue to receive the multicast transmissions from the DU 50 even after the UE 3 has transitioned to the RRC inactive state.

If the UE 3 is the only UE 3 in the cell that is in the RRC connected state and is to use an MBS session, then when the CU 60 releases the RRC connection of the UE 3 using the UE Context Release Request, advantageously the CU 60 can indicate to the DU 50 using the list of MRB to be maintained for the UE 3 (or the indication that all of the MRB for PTM transmission to the UE 3 are to be maintained) that the DU 50 is to maintain a PTM transmission for the UE 3. Therefore, the UE 3 able to continue to receive the PTM transmission even after there are no more UEs 3 in the cell in the RRC connected state (which may otherwise cause the DU 50 to discontinue the PTM transmissions). Moreover, since the RRC release message received at the UE 3 from the DU 50 includes the list of MRB to be maintained, the UE 3 is able to perform control to receive the corresponding PTM transmissions.

MRB for PTM transmission are configured when the UE 3 is in an RRC connected state. The PTM RLC entities for different UEs 3 may be different, since the PTM RLC entity of each UE 3 is configured individually. An RLC configuration may include, amongst other information, a logical channel identity (e.g. ‘logicalChannelIdentity’) and a multicast RLC bearer configuration. In this example when a UE 3 RRC connection is released to the inactive state and the UE 3 maintains a PTM RLC entity (e.g. based on the MRB list received from the DU 50), the network (e.g. base station 5) maintains the corresponding PTM RLC entity at the network. More generally, since a configuration used for PTM for a particular UE 3 may be different to a configuration used for PTM for another UE 3, when a particular UE 3 is to maintain a configuration for PTM based on the method shown in FIG. 9, the configuration is also maintained at the network (e.g. at the DU 50).

### RLC Configuration

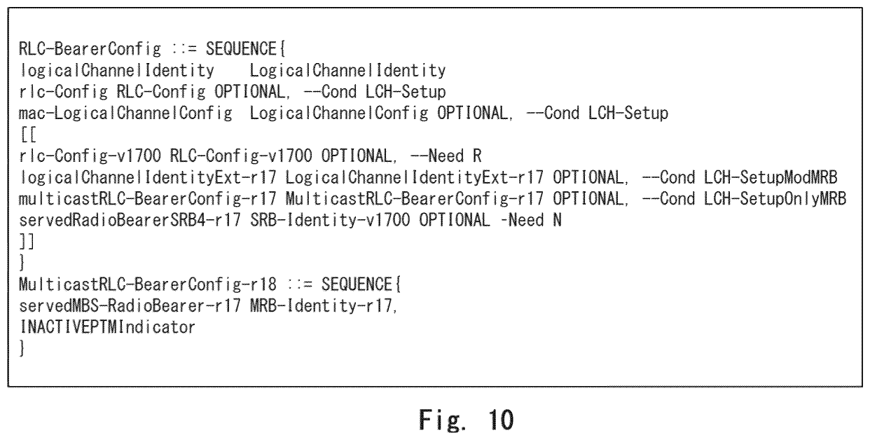

Alternatively, or additionally, an RLC configuration may be used to indicate the PTM to be maintained for the UE 3. For example, an RLC bearer configuration may include an indication that the UE 3 can use the PTM configuration when it is in the RRC inactive state. The indication may also be referred to as a ‘multicast indication’. An example of such an RLC bearer configuration that may be transmitted to the UE 3 is shown in FIG. 10. As shown in FIG. 10, the RLC configuration includes an indication that the UE 3 can use the PTM configuration when it is in the RRC inactive state. In the example of FIG. 10, the indication is ‘INACTIVEPTMIndicator’, which may be, for example: ‘TRUE’ or ‘FALSE’: or similarly, ‘1’ or ‘0’, to indicate whether the UE 3 can use the PTM configuration when it is in the RRC inactive state.

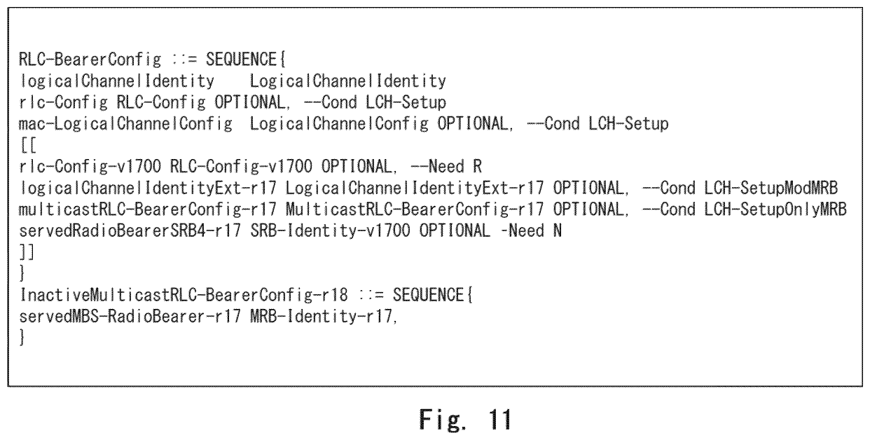

FIG. 11 shows an alternative in which rather than including a separate indication with the list of MBS radio bearers, the multicast RLC bearer configuration for the UE in the inactive state is provided separately (in this example, as ‘InactiveMulticastRLC-BearerConfig-r18’). If InactiveMulticastRLC-BearerConfig-r18 is included in the RLC configuration, then the UE 3 can use the corresponding PTM configuration when the UE 3 is in the RRC inactive state.

### Cell Reselection

When a UE 3 is receiving a multicast service and then performs cell reselection in the RRC inactive state (cell reselection without resuming the RRC connection), it may be possible to continue receiving the multicast service in the new cell. In particular, continuity of the multicast service can be supported if the configuration of the multicast service in the new cell is available to the UE 3 (for example, if the UE 3 has received the configuration of the multicast service in the new cell from the network). If the configuration of the multicast service in the new cell is not available to the UE 3, then the UE 3 may resume the RRC connection (enter the RRC connected state) to obtain the multicast MRB configuration from the network.

Configuration for Multicast when UE is RRC Inactive

As described above, after a UE 3 joins a multicast session the UE 3 can transition from the RRC connected state to the RRC inactive state (e.g. according to any of the methods described above). However, it is possible for the MBS session to become inactive (e.g. due to a base station determining to make the MBS inactive due to a period of data inactivity, or due to there no longer being any UEs 3 in the cell in the RRC connected state). If the MBS session becomes inactive, the UE 3 may determine (e.g. independently of the base station 5) to enter the RRC inactive state in order to reduce power consumption.

There is a problem that when a UE 3 joins a multicast session the MBS configuration from the core network is obtained, but a corresponding MRB configuration is not transmitted to the UE 3 until the multicast session has been activated. However, the UE 3 may need to transition to the RRC connected state from the RRC inactive state in order to receive the configuration for the MRB.

Methods in which the UE enters the RRC connected state and receives an MRB configuration will now be described.

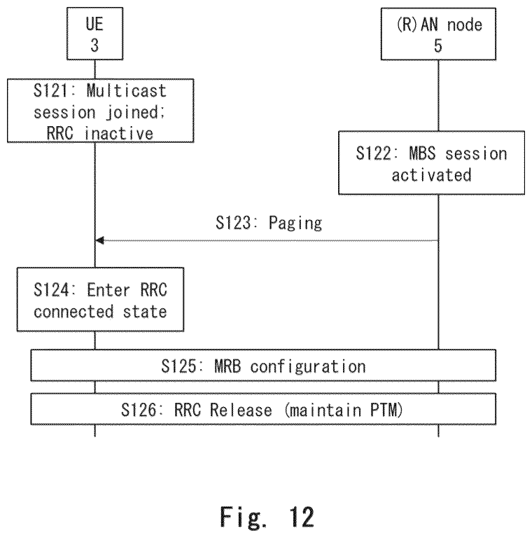

FIG. 12 shows an example in which the UE 3 receives a paging transmission from a (R)AN node 5 (e.g. a base station 5). In step S121 the UE 3 has joined a multicast session and is in the RRC inactive state.

In step S122 the MBS session is activated by the base station 5.

In step S123, the base station 5 transmits a paging transmission to the UE 3.

In step S124, in response to receiving the paging from the base station 5, the UE 5 enters the RRC connected state.

In step S125, when the UE 3 is in the RRC connected state, the UE 3 and the base station 5 communicate in order to provide an MRB configuration for the multicast to the UE 3.

In step S126 an RRC release procedure is performed in order to return the UE 3 to the inactive state (e.g. to reduce power consumption at the UE 3). The RRC release procedure may be, for example, any of the RRC release procedures described above with reference to FIGS. 7 to 11 that enable the UE 3 to continue to receive the multicast transmission even after the UE 3 has returned to the RRC inactive state.

Advantageously, in the method illustrated in FIG. 12, the UE 3 is able to obtain the configuration for the multicast despite initially being in the RRC inactive mode, and is able to return to the RRC inactive mode (which beneficially reduces power consumption, and may also reduce congestion in the cell) and continue to receive the multicast transmission at the end of the procedure.

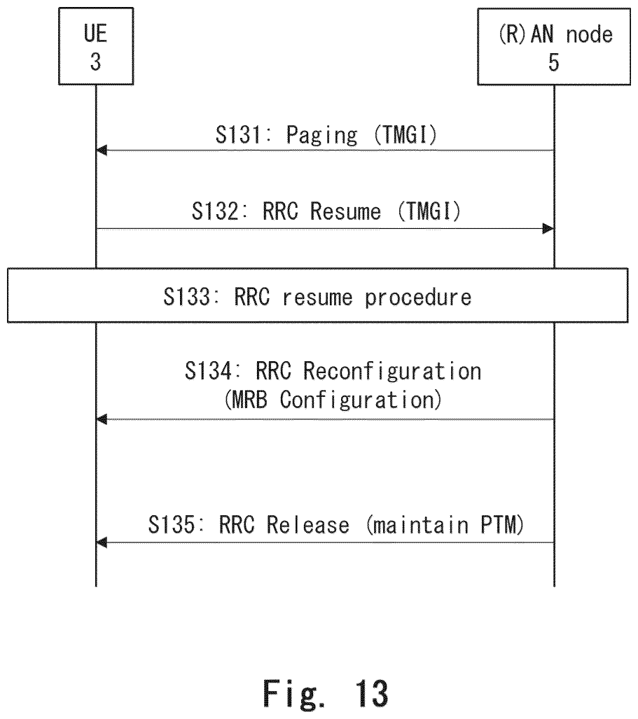

FIG. 13 illustrates a further example in which the UE enters the RRC connected state in order to receive information for receiving a multicast transmission. The network may activate multiple MBS sessions, and the network may not know which MBS session is to be used for a UE 3 unless the UE 3 provides a corresponding indication to the network. In the present example, a temporary mobile group identity (TMGI) is used to indicate a particular MBS session. The TMGI may be used to identify an MBS bearer service. If the TMGI is not reported by the UE 3 following paging from the base station 5, then the UE 3 may need to report the TMGI via additional signalling (e.g. using an ‘MBSinterestedIndication’ message). This causes additional delay, which is particularly disadvantageous for delay sensitive services. Therefore, it is advantageous to include the indication of the MBS session following the paging (e.g. directly in response to the paging) from the base station 5.

In step S131, when the MBS session is activated, the (R)AN node 5 (e.g. base station 5) transmits a paging message, that includes a TMGI of the MBS session (or a plurality of TMGI), to the UE 3.

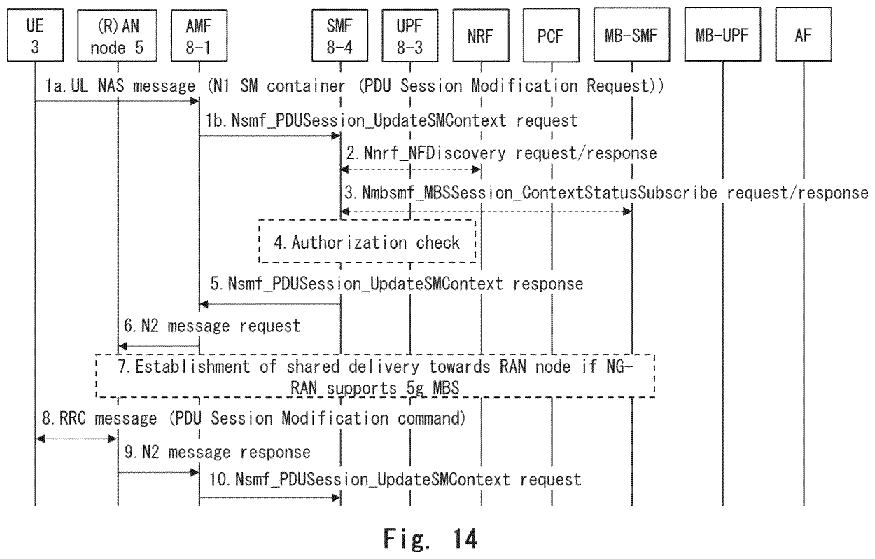

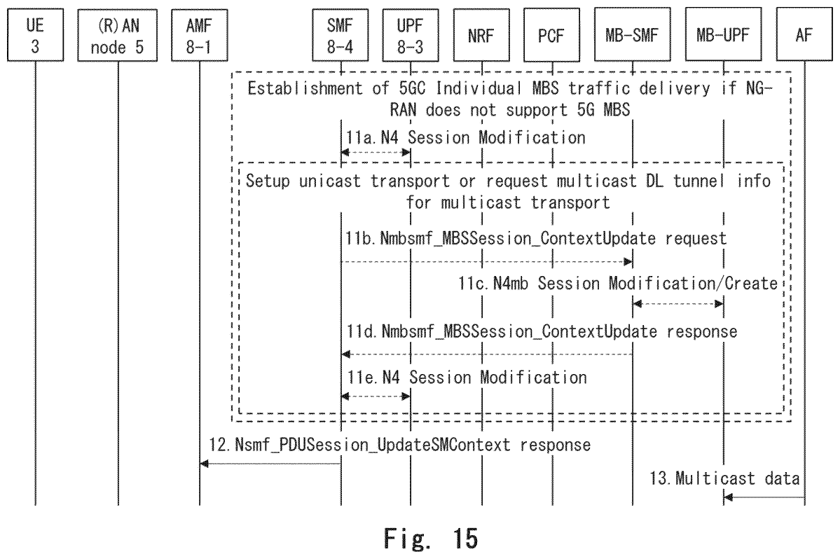

In step S132, after reception of the paging from the base station 5, the UE 3 transmits an RRC Resume message to the base station 5. The RRC Resume message includes the TMGI of an MBS service that the UE 3 is to receive. Advantageously, the provision of the TMGI in the RRC Resume message enables the network to identify the MBS service that the UE 3 is to receive. If the UE 3 does not notify the base station 5 of the TMGI in step S132, then the UE 3 may alternatively perform part (steps 1a to 8) of a multicast session join and session establishment procedure described, for example, in TS 23.247, and described later with reference to FIGS. 14 to 16.

In step S133 an RRC resume procedure is performed, in which the UE 3 enters the RRC connected state.

In step S134, after reception of the TMGI from the UE 3, the network configures a PTM leg for the UE 3. An RRC Reconfiguration message that includes an indication of a corresponding MRB configuration is then transmitted to the UE 3 from the base station 5. Since the UE 3 now has the MRB configuration, the UE 3 is able to receive the multicast from the base station 5.

In step S135 an RRC Release procedure is performed in order to return the UE 3 to the inactive state (e.g. to reduce power consumption at the UE 3). The RRC release procedure may be, for example, any of the RRC release procedures described above with reference to FIGS. 7 to 11 that enable the UE 3 to continue to receive the multicast transmission (a procedure in which the PTM leg is maintained) even after the UE 3 has returned to the RRC inactive state.

Advantageously, at the end of the procedure the UE 3 has the MRB configuration for receiving the multicast, and has returned to the RRC inactive state, reducing power consumption at the UE 3 during the subsequent reception of the multicast.

FIGS. 14 to 16 illustrate a multicast session join and session establishment procedure described in more detail, for example, in TS 23.247 V17.4.0.

In step 1a the UE 3 transmits an uplink (UL) non-access stratum (NAS) message to the AMF 8-1.

In step 1b the AMF 8-1 transmits an Nsmf_PDUSession_UpdateSMContext request to the SMF 8-4.

In step 2, Nnrf_NFDiscovery request/response is transmitted between the SMF 8-4 and the Network Repository Function (NRF).

In step 3, Nmbsmf_MBSSession_ContextStatusSubscribe request/response is transmitted between the SMF 8-4 and the NRF.

In step 4, an authorization check procedure is performed at the SMF 8-4 and the UPF 8-3.

In step 5, a Nsmf_PDUSession_UpdateSMContext response is transmitted from the SMF 8-4 to the AMF 8-1.

In step 6, an N2 message request is transmitted from the AMF 8-1 to the (R)AN node 5.

In step 7, a procedure for establishment of shared delivery towards RAN node if NG-RAN supports 5 g MBS is performed.

In step 8, an RRC message (PDU Session Modification command) is exchanged between the UE 3 and the (R)AN node 5.

In step 9, an N2 message response is transmitted from the (R)AN node 5 to the AMF 8-1.

In step 10, an Nsmf_PDUSession_UpdateSMContext request is transmitted from the AMF 8-1 to the SMF 8-4.

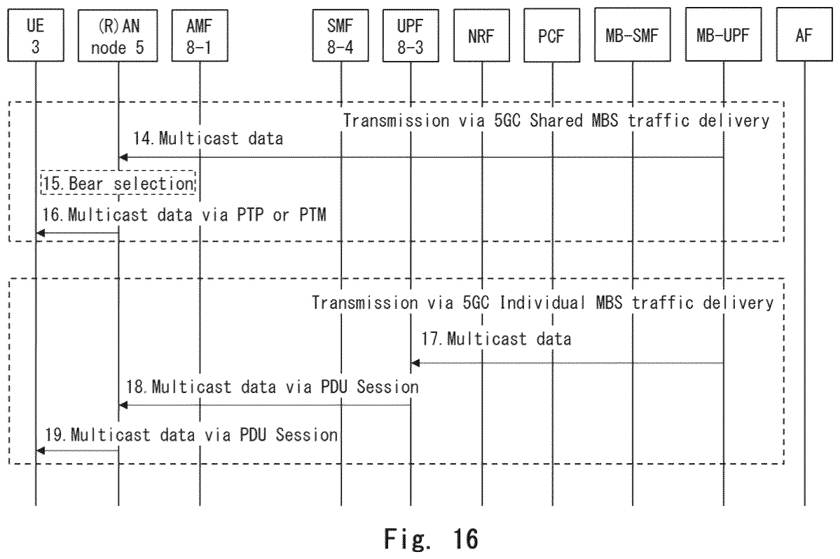

Turning now to FIG. 16, an establishment of 5GC Individual MBS traffic delivery if NG-RAN does not support 5G MBS is shown.

In step 11a, a N4 Session Modification message is exchanged between the SMF 8-4 and the UPF 8-3. A procedure for setup of unicast transport or request multicast DL tunnel info for multicast transport is then performed.

In step 11b, a Nmbsmf_MBSSession_ContextUpdate request is transmitted from the SMF 8-4 to the MB-SMF.

In step 11c, an N4mb Session Modification/Create message is exchanged between the MB-SMF and the MB-UPF.

In step 11d, an Nmbsmf_MBSSession_ContextUpdate response is transmitted from the MB-SMF to the SMF 8-4.

In step 11e, and N4 Session Modification message is exchanged between the SMF 8-4 and the UPF 8-3.

In step 12, an Nsmf_PDUSession_UpdateSMContext response message is transmitted from the SMF 8-4 to the AMF 8-1.

In step 13, multicast data is transmitted from the AF to the MB-UPF.

FIG. 16 shows transmission via 5GC Shared MBS traffic delivery is then performed. In step 14, the multicast data is transmitted from the MB-UPF to the (R)AN node 5.

In step 15, bearer selection is performed at the (R)AN node 5.

In step 16, multicast data is transmitted from the (R)AN node 5 to the UE 3 via PTP or PTM.

FIG. 16 also shows transmission via 5GC Individual MBS traffic delivery. In step 17, multicast data is transmitted from the MB-UPF to the UPF 8-3.

In step 18, multicast data via PDU session is transmitted from the UPF 8-3 to the (R)AN node 5.

In step 19, multicast data via PDU session is transmitted from the (R)AN node 5 to the UE 3.

### Reducing Occurrence of RRC Connected Mode

Whilst in some of the methods described above it is advantageous for the UE 3 to return to the RRC Connected mode in order to receive information for receiving the multicast (e.g. MRB configuration), it is also advantageous to reduce the number of times the UE 3 enters the RRC connected state. For example, it is advantageous to avoid a situation in which the multicast configuration changes and causes many UEs to simultaneously enter the RRC connected state to obtain the new configuration, since this may cause congestion on the random access channel (RACH). Advantageously, in this example, a UE 3 does not enter the RRC connected state when the UE 3 already has a configuration for PTM transmission of a multicast.

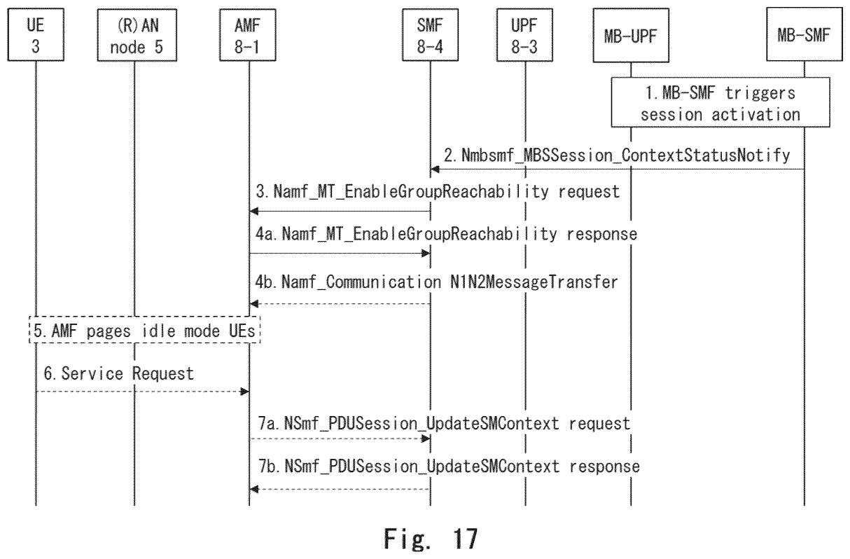

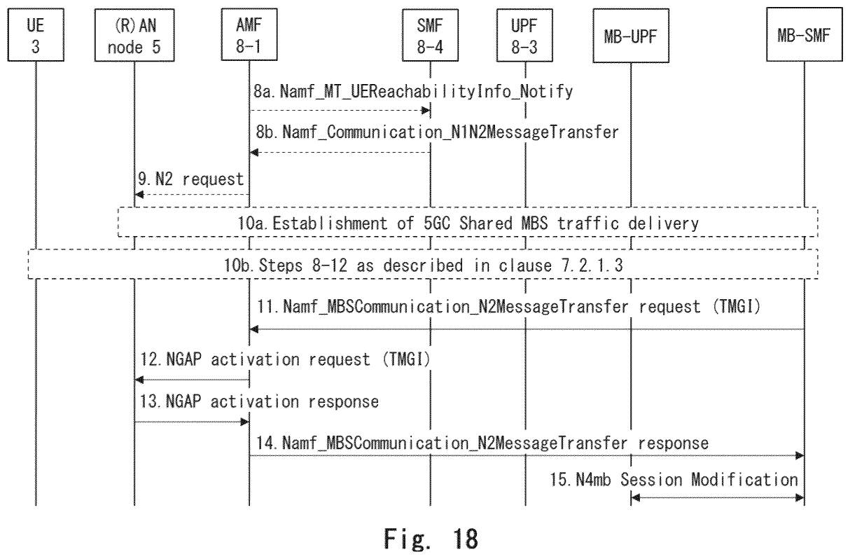

FIGS. 17 and 18 show an MBS session activation and deactivation procedure, described in more detail in TS 23.247 V17.4.0.

In step 1, the MB-SMF triggers session activation.

In step 2, NMBsmf_MBSSession_ContextStatusNotify is transmitted from the MB-SMF to the SMF 8-4.

In step 3, an Namf_MT_EnableGroupReachability request is transmitted from the SMF 8-4 to the AMF 8-1.

In step 4a, an Namf_MT_EnableGroupReachability response is transmitted from the AMF 8-1 to the SMF 8-4.

In step 4b, an Namf_Communication NIN2MessageTransfer is transmitted from the SMF 8-4 to the AMF 8-1.

In step 5, the AMF pages idle mode UEs.

In step 6, a Service Request is transmitted from the UE 3 to the AMF 8-1.

In step 7a, an NSmf_PDUSession_UpdateSMContext request is transmitted from the AMF 8-1 to the SMF 8-4.

In step 7b, an NSmf_PDUSession_UpdateSMContext response is transmitted from the SMF 8-4 to the AMF 8-1.

Turning now to FIG. 18, in step 8a an Namf_MT_UEReachabilityInfo_Notify is transmitted from the AMF 8-1 to the SMF 8-4.

In step 8b, an Namf_Communication_NIN2MessageTransfer is transmitted from the SMF 8-4 to the AMF 8-1.

In step 9, an N2 request is transmitted from the AMF 8-1 to the (R)AN node 5.

In step 10a, establishment of 5GC Shared MBS traffic delivery is performed.

In step 10b, steps 8-12 as described in clause 7.2.1.3 of TS 23.247 V17.4.0 are performed.

In step 11, Namf_MBSCommunication_N2Message Transfer request (TMGI) is transmitted from the MB-SMF to the AMF 8-1.

In step 12, a NGAP activation request (TMGI) is transmitted from the AMF 8-1 to the (R)AN node 5.

In step 13, a NGAP activation response is transmitted from the (R)AN node 5 to the AMF 8-1.

In step 14, an Namf_MBSCommunication_N2Message Transfer response is transmitted from the AMF 8-1 to the MB-SMF.

In step 15, a N4mb Session Modification message is exchanged between the MB-UPF and the MB-SMF.

In step 12 of the procedure shown in FIG. 18, the AMF 8-1 transmits an NGAP activation request message to the (R)AN node 5, and the UE 3 subsequently receives paging from the (R)AN node 5 so that the UE 3 can receive a corresponding configuration for PTM. In a situation in which a UE 3 has joined an MBS session but is now in the RRC inactive state, if the UE 3 has been configured with the PTM configuration before entering the RRC inactive state then the UE 3 does not need to enter the RRC connected state to obtain a PTM configuration. However, the UE 3 may enter the RRC connected state in response to receiving the paging from the (R)AN node 5. Improved methods in which the UE 3 does not enter the RRC connected state if the PTM configuration is available at the UE 3 will now be described.

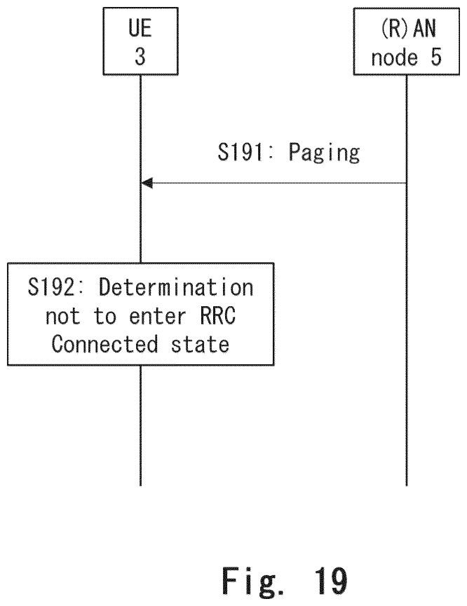

FIG. 19 shows an example in which the UE 3, after having receiving paging from the (R)AN node 5, does not enter the RRC connected state if a PTM configuration is available at the UE 3. It will be appreciated that the paging in FIG. 19 need not necessarily be the paging corresponding to the method illustrated in FIGS. 17 and 18, and that the paging may be any other suitable paging from the (R)AN node 5. More generally, the (R)AN node 5 may determine to transmit a transmission to the UE 3 for causing the UE 3 to enter the RRC connected state so that a configuration for PTM can be received, but in the present example the UE 3 will advantageously nevertheless remain in the RRC inactive state if the UE 3 already has the configuration for PTM available (e.g. stored) at the UE 3.

In step 191 paging is transmitted from the (R)AN node 5 to the UE 3. The paging may be for causing the UE 3 to enter the RRC connected state so that a configuration for PTM can be transmitted from the (R)AN node 5 to the UE 3.

In step 192, the UE 3 determines not to enter the RRC Connected state, even though the paging has been received from the (R)AN node 5. The UE 3 may determine not to enter the RRC Connected state based on information for multicast stored at the UE 3 (e.g. a MRB configuration for PTM stored at the UE 3). Advantageously, therefore, the UE 3 does not unnecessarily transition to the RRC Connected state, reducing the power consumption and the UE 3 and reducing the risk of network congestion.

Alternatively, the (R)AN node 5 may determine that the UE 3 already has the PTM configuration available at the UE 3, and may determine not to transmit the paging to the UE 3. The (R)AN node 5 may determine that the UE 3 already has the PTM configuration, for example, based on a PTM configuration previously transmitted from the (R)AN node 5 to the UE 3. If the (R)AN node 5 is not the same (R)AN node 5 that previously transmitted the PTM configuration to the UE 3, then the (R)AN node 5 may receive an indication from the network that the UE 3 already has the PTM configuration, and determine not to transmit corresponding paging to the UE 3.

### Modifications and Alternatives

Detailed example embodiments have been described above. As those skilled in the art will appreciate, a number of modifications and alternatives can be made to the above example embodiments whilst still benefiting from the present disclosure embodied therein. By way of illustration only a number of these alternatives and modifications will now be described.

Whilst a base station of a 5G/NR communication system is commonly referred to as a New Radio Base Station (‘NR-BS’) or as a ‘gNB’ it will be appreciated that they may be referred to using the term ‘eNB’ (or 5G/NR eNB) which is more typically associated with Long Term Evolution (LTE) base stations (also commonly referred to as ‘4G’ base stations). 3GPP Technical Specification (TS) 38.300 V16.7.0 and TS 37.340 V16.7.0 define the following nodes, amongst others:
gNB: node providing NR user plane and control plane protocol terminations towards the UE, and connected via the NG interface to the 5G core network (5GC).
ng-eNB: node providing E-UTRA user plane and control plane protocol terminations towards the UE, and connected via the NG interface to the 5GC. En-gNB: node providing NR user plane and control plane protocol terminations towards the UE, and acting as Secondary Node in E-UTRA-NR Dual Connectivity (EN-DC).
NG-RAN node: either a gNB or an ng-eNB.

It will be appreciated that the above example embodiments may be applied to both 5G New Radio and LTE systems (E-UTRAN). A base station (gateway) that supports E-UTRA/4G protocols may be referred to as an ‘eNB’ and a base station that supports NextGeneration/5G protocols may be referred to as a ‘gNBs’. It will be appreciated that some base stations may be configured to support both 4G and 5G protocols, and/or any other 3GPP or non-3GPP communication protocols.

Each cell may have an associated ‘NR Cell Global Identifier’ (NCGI) to identify the cell globally. The NCGI is constructed from the Public Land Mobile Network (PLMN) identity (PLMN ID) the cell belongs to and the NR Cell Identity (NCI) of the cell. The PLMN ID included in the NCGI is the first PLMN ID within the set of PLMN IDs associated to the NR Cell Identity in System Information Block Type 1 (SIB1). The ‘gNB Identifier’ (gNB ID) is used to identify a particular gNB within a PLMN. The gNB ID is contained within the NCI of its cells. The ‘Global gNB ID’ is used to identify a gNB globally and it is constructed from the PLMN identity the gNB belongs to and the gNB ID. The Mobile Country Code (MCC) and Mobile Network Code (MNC) are the same as included in the NCGI.

In the above description, the UE 3 and the access R (AN) node 5 are described for ease of understanding as having a number of discrete modules (such as the communication control modules). Whilst these modules may be provided in this way for certain applications, for example where an existing system has been modified to implement the present disclosure, in other applications, for example in systems designed with the inventive features in mind from the outset, these modules may be built into the overall operating system or code and so these modules may not be discernible as discrete entities. These modules may also be implemented in software, hardware, firmware, or a mix of these.

Each controller may comprise any suitable form of processing circuitry including (but not limited to), for example: one or more hardware implemented computer processors: microprocessors: central processing units (CPUs); arithmetic logic units (ALUs): input/output (IO) circuits; internal memories/caches (program and/or data): processing registers: communication buses (e.g. control, data and/or address buses): direct memory access (DMA) functions; hardware or software implemented counters, pointers and/or timers; and/or the like.

In the above example embodiments, a number of software modules were described. As those skilled in the art will appreciate, the software modules may be provided in compiled or un-compiled form and may be supplied as a signal over a computer network, or on a recording medium. Further, the functionality performed by part or all of this software may be performed using one or more dedicated hardware circuits. However, the use of software modules is preferred as it facilitates updating of functionalities.

The above example embodiments are also applicable to ‘non-mobile’ or generally stationary user equipment. The above-described mobile device (UE) may comprise an MTC/IoT device, a power saving UE, and/or the like.

The User Equipment 3 (or “UE”, “mobile station”, “mobile device” or “wireless device”) in the present disclosure is an entity connected to a network via a wireless interface.

It should be noted that the present disclosure is not limited to a dedicated communication device, and can be applied to any device having a communication function as explained in the following paragraphs.

The terms “User Equipment” or “UE” (as the term is used by 3GPP), “mobile station”, “mobile device”, and “wireless device” are generally intended to be synonymous with one another, and include standalone mobile stations, such as terminals, cell phones, smart phones, tablets, cellular IoT devices, IoT devices, and machinery. It will be appreciated that the terms “mobile station” and “mobile device” also encompass devices that remain stationary for a long period of time.

A UE may, for example, be an item of equipment for production or manufacture and/or an item of energy related machinery (for example equipment or machinery such as: boilers: engines: turbines: solar panels; wind turbines; hydroelectric generators: thermal power generators: nuclear electricity generators; batteries; nuclear systems and/or associated equipment: heavy electrical machinery: pumps including vacuum pumps: compressors: fans: blowers; oil hydraulic equipment; pneumatic equipment: metal working machinery; manipulators: robots and/or their application systems: tools: molds or dies: rolls: conveying equipment: elevating equipment: materials handling equipment: textile machinery; sewing machines; printing and/or related machinery: paper converting machinery: chemical machinery: mining and/or construction machinery and/or related equipment; machinery and/or implements for agriculture, forestry and/or fisheries: safety and/or environment preservation equipment: tractors; precision bearings: chains; gears: power transmission equipment: lubricating equipment: valves: pipe fittings; and/or application systems for any of the previously mentioned equipment or machinery etc.).

A UE may, for example, be an item of transport equipment (for example transport equipment such as: rolling stocks: (motor) vehicles: motorcycles; bicycles: trains: buses; carts: rickshaws; ships and other watercraft; aircraft; rockets: satellites: drones: balloons etc.).

A UE may, for example, be an item of information and communication equipment (for example information and communication equipment such as: electronic computer and related equipment: communication and related equipment: electronic components etc.).

A UE may, for example, be a refrigerating machine, a refrigerating machine applied product, an item of trade and/or service industry equipment, a vending machine, an automatic service machine, an office machine or equipment, a consumer electronic and electronic appliance (for example a consumer electronic appliance such as: audio equipment: video equipment: a loud speaker: a radio; a television: a microwave oven; a rice cooker: a coffee machine: a dishwasher: a washing machine: a dryer: an electronic fan or related appliance: a cleaner etc.).

A UE may, for example, be an electrical application system or equipment (for example an electrical application system or equipment such as: an x-ray system; a particle accelerator: radio isotope equipment: sonic equipment: electromagnetic application equipment: electronic power application equipment etc.).

A UE may, for example, be an electronic lamp, a luminaire, a measuring instrument, an analyser, a tester, or a surveying or sensing instrument (for example a surveying or sensing instrument such as: a smoke alarm; a human alarm sensor: a motion sensor: a wireless tag etc.), a watch or clock, a laboratory instrument, optical apparatus, medical equipment and/or system, a weapon, an item of cutlery, a hand tool, or the like.

A UE may, for example, be a wireless-equipped personal digital assistant or related equipment (such as a wireless card or module designed for attachment to or for insertion into another electronic device (for example a personal computer, electrical measuring machine)).

A UE may be a device or a part of a system that provides applications, services, and solutions described below, as to ‘internet of things’ (IOT), using a variety of wired and/or wireless communication technologies.

Internet of Things devices (or “things”) may be equipped with appropriate electronics, software, sensors, network connectivity, and/or the like, which enable these devices to collect and exchange data with each other and with other communication devices. IoT devices may comprise automated equipment that follow software instructions stored in an internal memory. IoT devices may operate without requiring human supervision or interaction. IoT devices might also remain stationary and/or inactive for a long period of time. IoT devices may be implemented as a part of a (generally) stationary apparatus. IoT devices may also be embedded in non-stationary apparatus (e.g. vehicles) or attached to animals or persons to be monitored/tracked.

It will be appreciated that IoT technology can be implemented on any communication devices that can connect to a communications network for sending/receiving data, regardless of whether such communication devices are controlled by human input or software instructions stored in memory.

It will be appreciated that IoT devices are sometimes also referred to as Machine-Type Communication (MTC) devices or Machine-to-Machine (M2M) communication devices. It will be appreciated that a UE may support one or more IoT or MTC applications. Some examples of MTC applications are listed in the following table (source: 3GPP TS 22.368 V13.1.0, Annex B, the contents of which are incorporated herein by reference). This list is not exhaustive and is intended to be indicative of some examples of machine type communication applications.

| Service Area | MTC applications |
|---|---|
| Security | Surveillance systems |
| | Backup for landline |
| | Control of physical access (e.g. to buildings) |
| | Car/driver security |
| Tracking & Tracing | Fleet Management |
| | Order Management |
| | Pay as you drive |
| | Asset Tracking |
| | Navigation |
| | Traffic information |
| | Road tolling |
| | Road traffic optimisation/steering |
| Payment | Point of sales |
| | Vending machines |
| | Gaming machines |
| Health | Monitoring vital signs |
| | Supporting the aged or handicapped |
| | Web Access Telemedicine points |
| | Remote diagnostics |
| Remote Maintenance/ | Sensors |
| Control | Lighting |
| | Pumps |
| | Valves |
| | Elevator control |
| | Vending machine control |
| | Vehicle diagnostics |
| Metering | Power |
| | Gas |
| | Water |
| | Heating |
| | Grid control |
| | Industrial metering |
| Consumer Devices | Digital photo frame |
| | Digital camera |
| | eBook |

Applications, services, and solutions may be an Mobile Virtual Network Operator (MVNO) service, an emergency radio communication system, a Private Branch exchange (PBX) system, a PHS/Digital Cordless Telecommunications system, a Point of sale (POS) system, an advertise calling system, a Multimedia Broadcast and Multicast Service (MBMS), a Vehicle to Everything (V2X) system, a train radio system, a location related service, a Disaster/Emergency Wireless Communication Service, a community service, a video streaming service, a femto cell application service, a Voice over LTE (VOLTE) service, a charging service, a radio on demand service, a roaming service, an activity monitoring service, a telecom carrier/communication NW selection service, a functional restriction service, a Proof of Concept (PoC) service, a personal information management service, an ad-hoc network/Delay Tolerant Networking (DTN) service, etc.

Further, the above-described UE categories are merely examples of applications of the technical ideas and example embodiments described in the present document. Needless to say, these technical ideas and example embodiments are not limited to the above-described UE and various modifications can be made thereto.

This application is based upon and claims the benefit of priority from United Kingdom Patent Application No. 2215057.7, filed on Oct. 12, 2022, the disclosure of which is incorporated herein in its entirety by reference.

Various other modifications will be apparent to those skilled in the art and will not be described in further detail here.

### (Supplementary Note 1)

A method for a user equipment, UE, the method comprising:
receiving, from an access network node when the UE is in a radio resource control, RRC, connected state, a point-to-multipoint, PTM, transmission of a multicast;
receiving, from the access network node, a multicast indication that indicates a configuration for receiving the PTM transmission of the multicast;
determining, based on the multicast indication, that the PTM transmission of the multicast is supported for reception at the UE when the UE is in an RRC inactive state;
entering the RRC inactive state; and
receiving, in the RRC inactive state, from the access network node, the PTM transmission of the multicast using the configuration;
wherein the multicast indication includes an indication of one or more radio bearers for the PTM transmission of the multicast, for use by the UE to receive the PTM transmission of the multicast when the UE is in the RRC inactive state.

### (Supplementary Note 2)

The method according to Supplementary note 1, wherein the multicast indication is included in an RRC release message received at the UE from the access network node.

### (Supplementary Note 3)

The method according to Supplementary note 1, wherein the method comprises receiving, from the access network node, radio link control, RLC, configuration information that indicates that an RLC bearer for the multicast can be used when the UE is in the RRC inactive state.

### (Supplementary Note 4)

The method according to any preceding Supplementary note, wherein the multicast indication comprises an indication that all bearers for receiving PTM transmission are to be maintained at the UE when the UE is in the RRC inactive state.

### (Supplementary Note 5)

The method according to any preceding Supplementary note, wherein the multicast indication includes an indication of a set of radio bearers for the PTM transmission, for use by the UE to receive the PTM transmission of the multicast when the UE is in the RRC inactive state.

### (Supplementary Note 6)

The method according to Supplementary note 5, wherein the set of radio bearers is a subset of radio bearers for the PTM transmission associated with the access network node, for use by the UE to receive the PTM transmission of the multicast when the UE is in the RRC inactive state.

### (Supplementary Note 7)

The method according to any preceding Supplementary note, wherein the method further comprises determining, based on the multicast indication, to maintain a PTM radio link control, RLC, entity of a radio bearer of the one or more radio bearers for the multicast.

### (Supplementary Note 8)

A method for a user equipment, UE, the method comprising:
joining a multicast session for receiving a PTM transmission of a multicast from an access network node;
entering a radio resource control, RRC, inactive state;
receiving, from the access network node when the multicast session is inactive, a transmission indicating that the UE is to enter an RRC connected state, wherein the transmission includes an indication of at least one multicast service supported by the access network node;
transmitting, to the access network node, in response to receiving the transmission indicating that the UE is to enter the RRC connected state, an indication of a PTM transmission of the multicast to be received at the UE;
entering an RRC connected state;
receiving, from the access network node, a bearer configuration for the PTM transmission;
entering the RRC inactive state in response to signalling received from the access network node that indicates that the UE is to enter the RRC inactive state and receive the PTM transmission; and
receiving, when the UE is in the RRC inactive state, the PTM transmission.

### (Supplementary Note 9)

The method according to Supplementary note 8, wherein the indication of the PTM transmission of the multicast to be received at the UE comprises a temporary mobile group identity, TMGI.

### (Supplementary Note 10)

The method according to Supplementary note 8 or 9, wherein the transmission indicating that the UE is to enter an RRC connected state is a paging transmission.

### (Supplementary Note 11)

The method according to any one of Supplementary notes 8 to 10, wherein the UE transmits the indication of the PTM transmission of the multicast to be received at the UE to the access network node in an RRC resume message, and the bearer configuration for the PTM transmission is received from the access network node in an RRC reconfiguration message.

### (Supplementary Note 12)

A method for a user equipment, UE, the method comprising:
receiving, from an access network node, when the UE is in a radio resource control, RRC, inactive state, a transmission for causing the UE to enter an RRC connected state; and
determining, based on multicast configuration information stored at the UE for receiving a multicast transmission from the access network node, to not to enter an RRC connected state in response to receiving the transmission from the access network node.

### (Supplementary Note 13)

The method according to Supplementary note 12, wherein the transmission for causing the UE to enter an RRC connected state is a paging transmission that includes a temporary mobile group identity, TMGI.

### (Supplementary Note 14)

The method according to Supplementary note 12 or 13, wherein the multicast configuration information comprises an indication of a configuration of at least one radio bearer for receiving the multicast transmission from the access network node.

### (Supplementary Note 15)

A method for an access network node the method comprising:
transmitting a point-to-multipoint, PTM, transmission of a multicast to a user equipment, UE, that is in a radio resource control, RRC, connected state; and
transmitting, to the UE, a multicast indication that indicates a configuration for receiving the PTM transmission of the multicast when the UE is in an RRC inactive state;
wherein the multicast indication includes an indication that the PTM transmission of the multicast is to be received at the UE when the UE is in the RRC inactive state; and
wherein the multicast indication includes an indication of one or more radio bearers for the PTM transmission of the multicast, for use by the UE to receive the PTM transmission of the multicast in the RRC inactive state.

### (Supplementary Note 16)

The method according to Supplementary note 15, wherein the multicast indication is transmitted to the UE in an RRC release message.

### (Supplementary Note 17)

The method according to Supplementary note 15, wherein the multicast indication is transmitted to the UE as part of radio link control, RLC, configuration information.

### (Supplementary Note 18)

The method according to any one of Supplementary notes 15 to 17, wherein the multicast indication comprises an indication that all bearers for receiving PTM transmission are to be maintained at the UE when the UE is in the RRC inactive state.

### (Supplementary Note 19)

The method according to any one of Supplementary notes 15 to 18, wherein the multicast indication includes an indication of a set of radio bearers for the PTM transmission, for use by the UE to receive the PTM transmission of the multicast when the UE is in the RRC inactive state.

### (Supplementary Note 20)

The method according to Supplementary note 19, wherein the set of radio bearers is a subset of radio bearers for the PTM transmission associated with the access network node, for use by the UE to receive the PTM transmission of the multicast when the UE is in the RRC inactive state.

### (Supplementary Note 21)

The method according to Supplementary note 19 or 20, wherein the method further comprises:
receiving, at a first part of the access network node for radio communication with the UE, from a second part of the access network node, an indication of the set of the bearers for the PTM transmission of the multicast.

### (Supplementary Note 22)

The method according to Supplementary note 21, wherein the indication of the set of bearers is received at the first part of the access network node from the second part of the access network node in an RRC context release request.

### (Supplementary Note 23)

The method according to Supplementary note 21 or 22, wherein the method further comprises:
determining, based on the indication of the set of bearers received at the first part of the access network node from the second part of the access network node, to continue to transmit a PTM transmission of the multicast using at least one bearer of the set of bearers.

### (Supplementary Note 24)

The method according to any one of Supplementary notes 21 to 23, wherein the first part of the access network node is a distributed unit of the access network node, and the second part of the access network node is a central unit of the access network node.

### (Supplementary Note 25)

The method according to any one of Supplementary notes 21 to 24, wherein the method further comprises determining, at the second part of the access network node, if there will be no UEs associated with the PTM transmission in a cell of the access network node in the RRC connected state, to transmit from the second part of the access network node to the first part of the access network node, an indication that the PTM transmission of the multicast is to be continued to be transmitted by the first part of the access network node.

### (Supplementary Note 26)

The method according to any one of Supplementary notes 15 to 25, wherein the method further comprises determining to maintain a PTM radio link control, RLC, entity associated with the UE when the UE is in the RRC inactive mode.

### (Supplementary Note 27)

A method for an access network node, the method comprising:
transmitting to a user equipment, UE, in a radio resource control, RRC, inactive state, when a multicast session provided by the access network node is inactive, a transmission indicating that the UE is to enter an RRC connected state, wherein the transmission includes an indication of at least one multicast service supported by the access network node;
receiving, from the UE, an indication of a PTM transmission to be received at the UE;
transmitting, to the UE, when the UE is in the RRC connected state, a bearer configuration for the PTM transmission;
transmitting, to the UE, a transmission that indicates that the UE is to enter the RRC inactive state and receive the PTM transmission; and
transmitting, to the UE, the PTM transmission.

### (Supplementary Note 28)

The method according to Supplementary note 27, wherein the indication of the PTM transmission of the multicast to be received at the UE comprises a temporary mobile group identity, TMGI.

### (Supplementary Note 29)

The method according to Supplementary note 27 or 28, wherein the transmission indicating that the UE is to enter an RRC connected state is a paging transmission.

### (Supplementary Note 30)

The method according to any one of Supplementary notes 27 to 29, wherein the indication of the PTM transmission of the multicast to be received at the UE is received from the UE in an RRC resume message, and the bearer configuration for the PTM transmission is transmitted to the UE in an RRC reconfiguration message.

### (Supplementary Note 31)

A user equipment, UE, comprising:
means for receiving, from an access network node when the UE is in a radio resource control, RRC, connected state, a point-to-multipoint, PTM, transmission of a multicast;
means for receiving, from the access network node, a multicast indication that indicates a configuration for receiving the PTM transmission of the multicast;
means for determining, based on the multicast indication, that the PTM transmission of the multicast is supported for reception at the UE when the UE is in an RRC inactive state;
means for entering the RRC inactive state; and
means for receiving, in the RRC inactive state, from the access network node, the PTM transmission of the multicast using the configuration;
wherein the multicast indication includes an indication of one or more radio bearers for the PTM transmission of the multicast, for use by the UE to receive the PTM transmission of the multicast when the UE is in the RRC inactive state.

### (Supplementary Note 32)

A user equipment, UE, comprising:
means for joining a multicast session for receiving a PTM transmission of a multicast from an access network node;
means for entering a radio resource control, RRC, inactive state;
means for receiving, from the access network node when the multicast session is inactive, a transmission indicating that the UE is to enter an RRC connected state, wherein the transmission includes an indication of at least one multicast service supported by the access network node;
means for transmitting, to the access network node, in response to receiving the transmission indicating that the UE is to enter the RRC connected state, an indication of a PTM transmission of the multicast to be received at the UE
means for entering an RRC connected state;
means for receiving, from the access network node, a bearer configuration for the PTM transmission;
means for entering the RRC inactive state in response to signalling received from the access network node that indicates that the UE is to enter the RRC inactive state and receive the PTM transmission; and
means for receiving, when the UE is in the RRC inactive state, the PTM transmission.

### (Supplementary Note 33)

A user equipment, UE, comprising:
means for receiving, from an access network node, when the UE is in a radio resource control, RRC, inactive state, a transmission for causing the UE to enter an RRC connected state; and
means for determining, based on multicast configuration information stored at the UE for receiving a multicast transmission from the access network node, to not to enter an RRC connected state in response to receiving the transmission from the access network node.

### (Supplementary Note 34)

An access network node comprising:
means for transmitting a point-to-multipoint, PTM, transmission of a multicast to a user equipment, UE, that is in a radio resource control, RRC, connected state; and
means for transmitting, to the UE, a multicast indication that indicates a configuration for receiving the PTM transmission of the multicast when the UE is in an RRC inactive state;
wherein the multicast indication includes an indication that the PTM transmission of the multicast is to be received at the UE when the UE is in the RRC inactive state; and
wherein the multicast indication includes an indication of one or more radio bearers for the PTM transmission of the multicast, for use by the UE to receive the PTM transmission of the multicast in the RRC inactive state.

### (Supplementary Note 35)

An access network node comprising:
means for transmitting to a user equipment, UE, in a radio resource control, RRC, inactive state, when a multicast session provided by the access network node is inactive, a transmission indicating that the UE is to enter an RRC connected state, wherein the transmission includes an indication of at least one multicast service supported by the access network node;
means for receiving, from the UE, an indication of a PTM transmission to be received at the UE;
means for transmitting, to the UE, when the UE is in the RRC connected state, a bearer configuration for the PTM transmission;
means for transmitting, to the UE, a transmission that indicates that the UE is to enter the RRC inactive state and receive the PTM transmission; and
means for transmitting, to the UE, the PTM transmission.

### REFERENCE SIGNS LIST

1 mobile (cellular or wireless) telecommunication system
3 mobile device
5 base station/(R)AN node
6 associated cell
7 core network
10 data network
21 transceiver circuit
22 antenna
23 controller
24 user interface
25 memory
26 operating system
27 communications control module
28 MBS module
29 RRC module
41 transceiver circuit
42 antenna
43 network interface
44 controller
45 memory
46 operating system
47 communications control module
48 MBS module
49 RRC module

What is claimed is:

1. A method for a mobile device, the method comprising:
receiving, from an access network node, a message for causing the UE mobile device to move to a radio resource control (RRC) inactive state, the message including information indicating that the mobile device can keep configuration for a point-to-multipoint (PTM) transmission of a multicast while the mobile device is in the RRC inactive state and information indicating a list of at least one corresponding multicast radio bearer (MRB); and
keeping the configuration for the PTM transmission on the at least one corresponding MRB while the mobile device is in the RRC inactive state, based on the information.

2. The method according to claim 1, wherein
the information includes an identity of a bearer for the PTM transmission, and
the keeping is performed by keeping the configuration for the PTM transmission corresponding to the bearer for the PTM transmission.

3. The method according to claim 1, wherein
the information includes an identity of a session of the PTM transmission, and
the keeping is performed by keeping the configuration for the PTM transmission corresponding to the session for the PTM transmission.

4. The method according to claim 1, wherein
the configuration for the PTM transmission includes radio link control (RLC) configuration that includes an indication indicating that an RLC bearer for the PTM transmission can be used in a case where the mobile device is in the RRC inactive state.

5. The method according to claim 1, further comprising:
determining, based on the information, to maintain a PTM radio link control (RLC) entity of a radio bearer of one or more radio bearers for the PTM transmission.

6. The method according to claim 1, wherein
the message includes an RRC release message.

7. The method according to claim 1, further comprising:
receiving, from the access network node, in a case where the mobile device is in an RRC connected state, the PTM transmission;
entering the RRC inactive state in response to the receiving the message; and
receiving, in the RRC inactive state, from the access network node, the PTM transmission using the configuration.

8. The method according to claim 1, further comprising:
joining a multicast session for receiving the PTM transmission;
entering the RRC inactive state;
receiving, from the access network node, in a case where the multicast session is inactive, a further message indicating that the mobile device is to enter an RRC connected state, wherein the further message includes an indication of at least one service of the PTM transmission supported by the access network node;
transmitting, to the access network node, in response to receiving the further message, an indication of a PTM transmission of the multicast to be received;
entering the RRC connected state;
receiving, from the access network node, a bearer configuration for the PTM transmission;
entering the RRC inactive state in response to the receiving the message; and
receiving, while the mobile device is in the RRC inactive state, the PTM transmission.

9. The method according to claim 8, wherein
the further message is a paging message.

10. The method according to any claim 8, wherein
the transmitting the indication of the PTM transmission of the multicast to be received is via an RRC resume message, and
the receiving the bearer configuration for the PTM transmission is via an RRC reconfiguration message.

11. A method for a mobile device the method comprising:
receiving, in a radio resource control (RRC) inactive state, from an access network node, a message for causing the mobile device to enter an RRC connected state; and
determining to enter the RRC connected state in a case where the mobile device does not store multicast configuration information for receiving a multicast transmission from the access network node.

12. The method according to claim 11, wherein
the message includes a paging message including a temporary mobile group identity, TMGI, and
the determining is performed by determining to enter the RRC connected state in a case where the mobile device does not store the multicast configuration information corresponding to the TMGI.

13. The method according to claim 11, wherein
the multicast configuration information includes information indicating a list of at least one corresponding multicast radio bearer (MRB).

14. A method for an access network node, the method comprising:
transmitting, to a mobile device a message for causing the mobile device to move to a radio resource control (RRC) inactive state, the message including information indicating that the UE mobile device can keep configuration for a point-to-multipoint (PTM) transmission of a multicast while the mobile device is in the RRC inactive state and information indicating a list of at least one corresponding multicast radio bearer (MRB), wherein
the configuration for the PTM transmission on the at least one corresponding MRB is kept by the mobile device while the mobile device is in the RRC inactive state, based on the information.

15. A method for an access network node, the method comprising:
transmitting, to a mobile device, in a case where the UE mobile device is in a radio resource control (RRC) inactive state, a message for causing the mobile device to enter an RRC connected state, wherein
in a case where the mobile device does not store multicast configuration information for receiving a multicast transmission from the access network node, entering an RRC connected state is determined.

16. A mobile device comprising:
at least one memory configured to store instructions; and
at least one processor configured to execute the instructions to:
receive, from an access network node, a message for causing the mobile device to move to a radio resource control (RRC) inactive state, the message including information indicating that the mobile device can keep configuration for a point-to-multipoint (PTM) transmission of a multicast while the mobile device is in the RRC inactive state and information indicating a list of at least one corresponding multicast radio bearer (MRB); and
keep the configuration for the PTM transmission on the at least one corresponding MRB while the mobile device is in the RRC inactive state, based on the information.

17. A mobile device comprising:
at least one memory configured to store instructions; and
at least one processor configured to execute the instructions to:
receive, in a radio resource control (RRC) inactive state, from an access network node, a message for causing the mobile device to enter an RRC connected state; and
determine to enter the RRC connected state in a case where the mobile device does not store multicast configuration information for receiving a multicast transmission from the access network node.

18. An access network node comprising:
at least one memory configured to store instructions; and
at least one processor configured to execute the instructions to:
transmit, to a mobile device, a message for causing the mobile device to move to a radio resource control (RRC) inactive state, the message including information indicating that the mobile device can keep configuration for a point-to-multipoint (PTM) transmission of a multicast while the mobile device is in the RRC inactive state and information indicating a list of at least one corresponding multicast radio bearer (MRB), wherein
the configuration for the PTM transmission on the at least one corresponding MRB is kept by the mobile device while the mobile device is in the RRC inactive state, based on the information.

19. An access network node comprising:
at least one memory configured to store instructions; and
at least one processor configured to execute the instructions to:
transmit, to a mobile device in a case where the mobile device is in a radio resource control (RRC) inactive state, a message for causing the mobile device to enter an RRC connected state, wherein
in a case where the mobile device does not store multicast configuration information for receiving a multicast transmission from the access network node, entering an RRC connected state is determined.
